(19) United States
(12) Patent Application Publication
(10) Pub. No.: US 2024/0165665 A1
(43) Pub. Date: May 23, 2024

(54) VIBRATION APPARATUS AND APPARATUS INCLUDING THE SAME

(71) Applicant: LG DISPLAY CO., LTD., SEOUL (KR)

(72) Inventors: SangWoo JIN, Gyeonggi-do (KR); Yong-Su HAM, Gyeonggi-do (KR); Minji KIM, Gyeonggi-do (KR); Eun ROH, Gyeonggi-do (KR)

(73) Assignee: LG DISPLAY CO., LTD., SEOUL (KR)

(21) Appl. No.: 18/384,903

(22) Filed: Oct. 30, 2023

(30) Foreign Application Priority Data
Nov. 23, 2022 (KR) 10-2022-0158375

(51) Int. Cl. B06B 1/06; B06B 1/02

(52) U.S. Cl. CPC B06B 1/0618; B06B 1/0207

(57) ABSTRACT

A vibration apparatus includes a vibration layer including a piezoelectric material, a first electrode layer at a first surface of the vibration layer, a second electrode layer at a second surface of the vibration layer different from the first surface, and a discharge member electrically connected to the first electrode layer and the second electrode layer.

### CROSS-REFERENCE TO RELATED APPLICATION

This application claims the priority of the Korean Patent Application No. 10-2022-0158375 filed on Nov. 23, 2022, which is hereby incorporated by reference in its entirety.

### BACKGROUND

### Field of the Disclosure

The present disclosure relates to a vibration apparatus and an apparatus including the same.

### Description of the Background

Recently, the need for slimming and thinning electronic devices is increasing. Also, as speakers applied to electronic devices or the like need to slim and thin, instead of voice coils, piezoelectric elements capable of realizing a thin thickness are attracting much attention.

Speakers or vibration apparatuses with a piezoelectric element applied thereto may be driven or vibrated by a driving power or a driving signal supplied through a signal supply member.

### SUMMARY

An electric charge (or a residual electric charge) is generated in a piezoelectric device on the basis of a temperature change and/or bending in a state (e.g. an open circuit state) where the piezoelectric device is not driven (or not vibrated) due to electric charges (or residual electric charges) accumulated in the piezoelectric device. Thus, the reliability of the piezoelectric device decreases and a sound characteristic and/or a sound pressure level characteristic are/is reduced.

Accordingly, the present disclosure is to provide a vibration apparatus having a new structure and an apparatus including the same, which may remove electric charges (or residual electric charges) accumulated in a piezoelectric device in various environments.

One or more aspects of the present disclosure are directed to providing a vibration apparatus and an apparatus including the same, in which reliability is improved and a sound characteristic and/or a sound pressure level characteristic are/is improved.

One or more aspects of the present disclosure are directed to providing a vibration apparatus, which may be connected to a signal supply member without a soldering process, and an apparatus including the vibration apparatus.

One or more aspects of the present disclosure are directed to providing a vibration apparatus with a signal supply member integrated therein and an apparatus including the vibration apparatus.

Additional features and aspects will be set forth in part in the description that follows, and in part will become apparent from the description, or may be learned by practice of the inventive concepts provided herein. Other features and aspects of the inventive concepts may be realized and attained by the structure particularly pointed out in the written description, or derivable therefrom, and the claims hereof as well as the appended drawings.

To achieve these and other aspects of the present disclosure, as embodied and broadly described herein, a vibration apparatus comprises a vibration layer including a piezoelectric material, a first electrode layer at a first surface of the vibration layer, a second electrode layer at a second surface of the vibration layer different from the first surface, and a discharge member electrically connected to the first electrode layer and the second electrode layer.

In one or more aspects, an apparatus comprises a passive vibration member, and/or at least one vibration generating apparatuses configured to vibrate the passive vibration member. The at least one vibration generating apparatus comprises the vibration apparatus. The vibration apparatus comprises a vibration layer including a piezoelectric material, a first electrode layer at a first surface of the vibration layer, a second electrode layer at a second surface of the vibration layer different from the first surface, and a discharge member electrically connected between the first electrode layer and the second electrode layer.

According to one or more aspects of the present disclosure, as electric charges (or residual electric charges) accumulated in a piezoelectric device are removed in various environments, the reliability of a vibration apparatus may be improved, and thus, a lifetime of the vibration apparatus may increase.

According to one or more aspects of the present disclosure, as electric charges (or residual electric charges) accumulated in a piezoelectric device are removed in various environments, a sound characteristic and/or a sound pressure level characteristic may be improved.

According to one or more aspects of the present disclosure, a signal supply member may be connected to a vibration apparatus without a soldering process, and thus, a hazard process may be improved.

According to one or more aspects of the present disclosure, as a signal supply member and a vibration apparatus are provided as one body, the signal supply member and the vibration apparatus may be configured as one part, and thus, an effect of uni-materialization may be obtained.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with aspects of the disclosure.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this disclosure, illustrate aspects of the disclosure and together with the description serve to explain principles of the disclosure.

FIG. 1 illustrates a vibration apparatus according to an aspect of the present disclosure.

FIG. 2 is a cross-sectional view taken along line I-I′ of FIG. 1.

FIG. 3 is a cross-sectional view taken along line II-IF of FIG. 1.

FIG. 4 illustrates a parallel connection structure of a vibration part and a discharge member illustrated in FIGS. 2 and 3.

FIG. 5 illustrates the conductive tape of the discharge member illustrated in FIGS. 1 and 3.

FIG. 6 illustrates a vibration apparatus according to another aspect of the present disclosure.

FIG. 7 illustrates a vibration apparatus according to another aspect of the present disclosure.

FIG. 8 illustrates a vibration apparatus according to another aspect of the present disclosure.

FIG. 9 illustrates a vibration apparatus according to another aspect of the present disclosure.

FIG. 10 illustrates a vibration driving circuit according to an aspect of the present disclosure.

FIG. 11 illustrates a vibration layer according to another aspect of the present disclosure.

FIG. 12 illustrates a vibration layer according to another aspect of the present disclosure.

FIG. 13 illustrates an apparatus according to an aspect of the present disclosure.

FIG. 14 is a cross-sectional view taken along line of FIG. 13.

FIG. 15A illustrates a sound output characteristic of a vibration apparatus according to an experimental example.

FIG. 15B illustrates a sound output characteristic of a vibration apparatus according to an aspect of the present disclosure.

FIG. 15C illustrates a sound output characteristic of a vibration apparatus according to another aspect of the present disclosure.

FIG. 16A illustrates a sound output characteristic of a vibration apparatus according to an experimental example with respect to a thermal shock.

FIG. 16B illustrates a sound output characteristic of a vibration apparatus according to an aspect of the present disclosure with respect to a thermal shock.

FIG. 16C illustrates a sound output characteristic of a vibration apparatus according to another aspect of the present disclosure with respect to a thermal shock.

Throughout the drawings and the detailed description, unless otherwise described, the same drawing reference numerals should be understood to refer to the same elements, features, and structures. The sizes, lengths, and thicknesses of layers, regions and elements, and depiction of thereof may be exaggerated for clarity, illustration, and/or convenience.

### DETAILED DESCRIPTION

Reference is now made in detail to aspects of the present disclosure, examples of which may be illustrated in the accompanying drawings. In the following description, when a detailed description of well-known functions or configurations may unnecessarily obscure aspects of the present disclosure, the detailed description thereof may be omitted for brevity. The progression of processing steps and/or operations described is an example; however, the sequence of steps and/or operations is not limited to that set forth herein and may be changed, with the exception of steps and/or operations necessarily occurring in a particular order.

Advantages and features of the present disclosure, and implementation methods thereof, are clarified through the aspects described with reference to the accompanying drawings. The present disclosure may, however, be embodied in different forms and should not be construed as limited to the aspects set forth herein. Rather, these aspects are examples and are provided so that this disclosure may be thorough and complete to assist those skilled in the art to understand the inventive concepts without limiting the protected scope of the present disclosure.

The shapes, sizes, areas, ratios, angles, numbers, and the like disclosed in the drawings for describing aspects of the present disclosure are merely an example, and thus, the present disclosure is not limited to the illustrated details. Like reference numerals refer to like elements throughout.

When the term “comprise,” “have,” “include,” “contain,” “constitute,” “make up of,” “formed of,” or the like is used, one or more other elements may be added unless a term such as “only” or the like is used. The terms used in the present disclosure are merely used to describe particular aspects, and are not intended to limit the scope of the present disclosure. The terms used herein are merely used to describe example aspects, and are not intended to limit the scope of the present disclosure. The terms of a singular form may include plural forms unless the context clearly indicates otherwise. The word “exemplary” is used to mean serving as an example or illustration. Aspects are example aspects. Any implementation described herein as an “example” is not necessarily to be construed as preferred or advantageous over other implementations.

In one or more aspects, an element, feature, or corresponding information (e. g., a level, range, dimension, size, or the like) is construed as including an error or tolerance range even where no explicit description of such an error or tolerance range is provided. An error or tolerance range may be caused by various factors (e. g., process factors, internal or external impact, noise, or the like). Further, the term “may” encompasses all the meanings of the term “may.”

In describing a positional relationship, where the positional relationship between two parts is described, for example, using “on,” “over,” “under,” “above,” “below,” “beneath,” “near,” “close to,” “adjacent to,” “beside,” “next to,” or the like, one or more other parts may be located between the two parts unless a more limiting term, such as “immediate(ly),” “direct(ly),” or “close(ly),” is used. For example, when a structure is described as being positioned “on,” “over,” “under,” “above,” “below,” “beneath,” “near,” “close to,” “adjacent to,” “beside,” or “next to” another structure, this description should be construed as including a case in which the structures contact each other as well as a case in which one or more additional structures are disposed or interposed therebetween. Furthermore, the terms “front,” “rear,” “back,” “left,” “right,” “top,” “bottom,” “downward,” “upward,” “upper,” “lower,” “up,” “down,” “column,” “row,” “vertical,” “horizontal,” and the like refer to an arbitrary frame of reference.

In describing a temporal relationship, when the temporal order is described as, for example, “after,” “subsequent,” “next,” “before,” “preceding,” “prior to,” or the like a case that is not consecutive or not sequential may be included unless a more limiting term, such as “just,” “immediate(ly),” or “direct(ly)” is used.

It will be understood that, although the term “first,” “second,” or the like may be used herein to describe various elements, these elements should not be limited by these terms. These terms are only used to distinguish one element from another. For example, a first element could be a second element, and, similarly, a second element could be a first element, without departing from the scope of the present disclosure. Furthermore, the first element, the second element, and the like may be arbitrarily named according to the convenience of those skilled in the art without departing from the scope of the present disclosure. The terms “first,” “second,” and the like may be used to distinguish components from each other, but the functions or structures of the components are not limited by ordinal numbers or component names in front of the components.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

For the expression that an element is “connected,” “coupled,” “attached,” or “adhered” to another element or layer the element or layer may not only be directly connected, coupled, attached, or adhered to another element or layer, but also be indirectly connected, coupled, attached, or adhered to another element or layer with one or more intervening elements or layers disposed or interposed between the elements or layers, unless otherwise specified.

For the expression that an element or layer “contacts,” “overlaps,” or the like with another element or layer, the element or layer may not only directly contact, overlap, or the like with another element or layer, but also indirectly contact, overlap, or the like with another element or layer with one or more intervening elements or layers disposed or interposed between the elements or layers, unless otherwise specified.

The terms such as a “line” or “direction” should not be interpreted only based on a geometrical relationship in which the respective lines or directions are parallel or perpendicular to each other, and may be meant as lines or directions having wider directivities within the range within which the components of the present disclosure may operate functionally.

The term “at least one” should be understood as including any and all combinations of one or more of the associated listed items. For example, the meaning of “at least one of a first item, a second item, and a third item” denotes the combination of all items proposed from two or more of the first item, the second item, and the third item as well as only one of the first item, the second item, and the third item.

The expression of a first element, a second elements “and/or” a third element should be understood as one of the first, second and third elements or as any or all combinations of the first, second and third elements. By way of example, A, B and/or C may refer to only A; only B; only C; any or some combination of A, B, and C; or all of A, B, and C. Furthermore, an expression “element A/element B” may be understood as element A and/or element B.

In one or more aspects, the terms “between” and “among” may be used interchangeably simply for convenience unless stated otherwise. For example, an expression “between a plurality of elements” may be understood as among a plurality of elements. In another example, an expression “among a plurality of elements” may be understood as between a plurality of elements. In one or more examples, the number of elements may be two. In one or more examples, the number of elements may be more than two.

In one or more aspects, the phrases “each other” and “one another” may be used interchangeably simply for convenience unless stated otherwise. For example, an expression “different from each other” may be understood as being different from one another. In another example, an expression “different from one another” may be understood as being different from each other. In one or more examples, the number of elements involved in the foregoing expression may be two. In one or more examples, the number of elements involved in the foregoing expression may be more than two.

In one or more aspects, the phrases “one or more among” and “one or more of” may be used interchangeably simply for convenience unless stated otherwise.

Features of various aspects of the present disclosure may be partially or wholly coupled to or combined with each other, and may be variously inter-operated, linked or driven together. The aspects of the present disclosure may be carried out independently from each other, or may be carried out together in a co-dependent or related relationship. In one or more aspects, the components of each apparatus according to various aspects of the present disclosure are operatively coupled and configured.

Unless otherwise defined, the terms (including technical and scientific terms) used herein have the same meaning as commonly understood by one of ordinary skill in the art to which example aspects belong. It is further understood that terms, such as those defined in commonly used dictionaries, should be interpreted as having a meaning that is, for example, consistent with their meaning in the context of the relevant art and should not be interpreted in an idealized or overly formal sense unless expressly defined otherwise herein.

In the following description, various example aspects of the present disclosure are described in detail with reference to the accompanying drawings. With respect to reference numerals to elements of each of the drawings, the same elements may be illustrated in other drawings, and like reference numerals may refer to like elements unless stated otherwise. In addition, for convenience of description, a scale, dimension, size, and thickness of each of the elements illustrated in the accompanying drawings may be different from an actual scale, dimension, size, and thickness, and thus, aspects of the present disclosure are not limited to a scale, dimension, size, and thickness illustrated in the drawings.

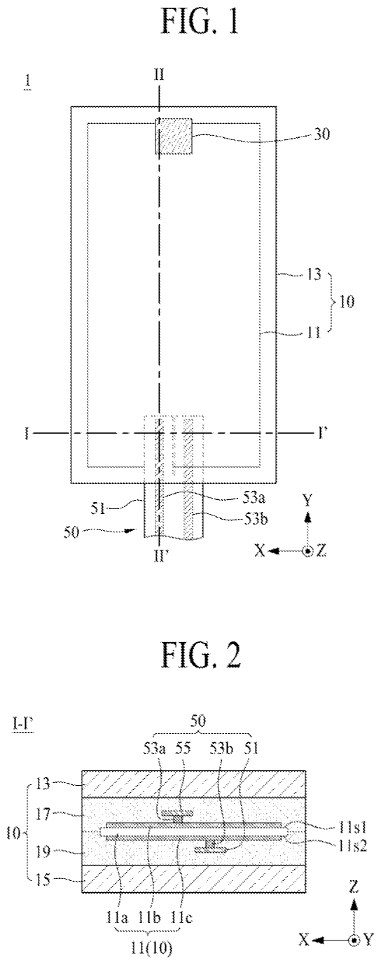

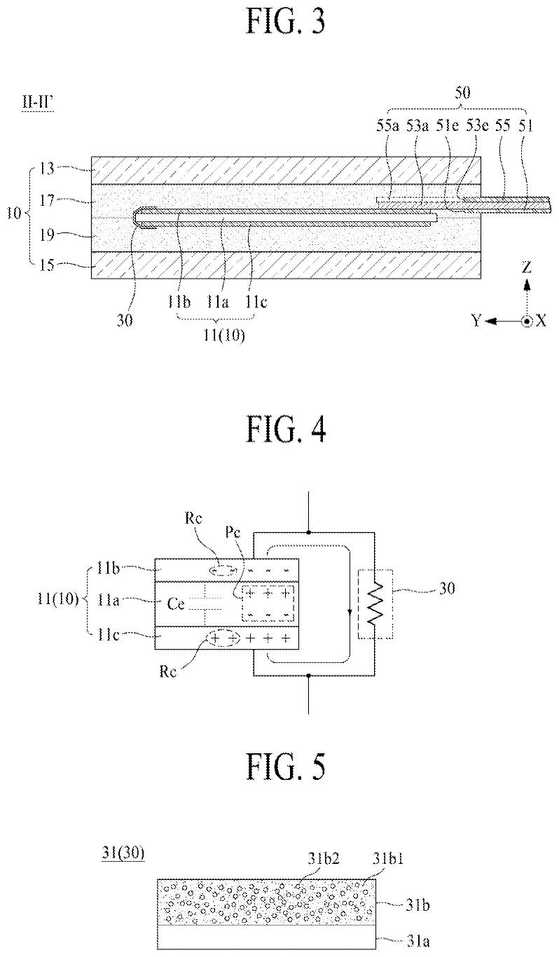

FIG. 1 illustrates a vibration apparatus according to an aspect of the present disclosure. FIG. 2 is a cross-sectional view taken along line I-I′ of FIG. 1. FIG. 3 is a cross-sectional view taken along line II-II′ of FIG. 1.

Referring to FIGS. 1 to 3, a vibration apparatus 1 according to an aspect of the present disclosure may include a vibration generating part 10 and a discharge member 30.

The vibration generating part 10 may be configured to vibrate based on a driving signal (or a sound signal or a voice signal). For example, the vibration generating part 10 may be a vibration device, a vibration generating device, a vibration film, a vibration generating film, a vibrator, a vibration generator, an active vibrator, an active vibration generator, or a passive vibration member or the like, but aspects of the present disclosure are not limited thereto.

The vibration generating part 10 according to an aspect of the present disclosure may include a vibration part 11. The vibration part 11 may be configured to vibrate based on a piezoelectric effect based on a driving signal. For example, the vibration part 11 may be a piezoelectric device, a piezoelectric device part, a piezoelectric device layer, a piezoelectric structure, or a piezoelectric vibration layer or the like, but aspects of the present disclosure are not limited thereto.

The vibration generating part 10 or the vibration part 11 according to an aspect of the present disclosure may include a vibration layer 11a, a first electrode layer 11b, and a second electrode layer 11c.

The vibration layer 11a may include a piezoelectric material or an electroactive material which includes a piezoelectric effect. For example, the piezoelectric material may have a characteristic in which, when pressure or twisting (or bending) is applied to a crystalline structure by an external force, a potential difference occurs due to dielectric polarization caused by a relative position change of a positive (+) ion and a negative (−) ion, and a vibration is generated by an electric field based on a reverse voltage applied thereto. For example, the vibration layer 11a may be a piezoelectric layer, a piezoelectric material layer, an electroactive layer, a piezoelectric composite layer, a piezoelectric composite, or a piezoelectric ceramic composite, or the like, but aspects of the present disclosure are not limited thereto.

The vibration layer 11a may be configured as a ceramic-based material have a capable of implementing a relatively strong vibration, or may be configured as a piezoelectric ceramic having a perovskite-based crystalline structure. The perovskite crystalline structure may have a piezoelectric effect and/or an inverse piezoelectric effect, and may be a plate-shaped structure having an orientation.

The piezoelectric ceramic may be configured as a single crystalline ceramic having a crystalline structure, or may be configured as a ceramic material having a polycrystalline structure or polycrystalline ceramic. A piezoelectric material including the single crystalline ceramic may include α-AlPO₄, α-SiO₂, LiNbO₃, Tb₂(MoO₄)₃, Li₂B₄O₇, or ZnO, but aspects of the present disclosure are not limited thereto. A piezoelectric material including the polycrystalline ceramic may include a lead zirconate titanate (PZT)-based material, including lead (Pb), zirconium (Zr), and titanium (Ti), or may include a lead zirconate nickel niobate (PZNN)-based material, including lead (Pb), zirconium (Zr), nickel (Ni), and niobium (Nb), but aspects of the present disclosure are not limited thereto. For example, the vibration layer 11a may include at least one or more of calcium titanate (CaTiO₃), barium titanate (BaTiO₃), and strontium titanate (SrTiO₃), without lead (Pb), but aspects of the present disclosure are not limited thereto.

The first electrode layer 11b may be disposed at a first surface (or an upper surface or a front surface) 11s1 of the vibration layer 11a. The first electrode layer 11b may have the same size as the vibration layer 11a, or may have a size which is smaller than the vibration layer 11a.

The second electrode layer 11c may be disposed at a second surface (or a lower surface or a rear surface) 11s2 which is opposite to or different from the first surface 11s1 of the vibration layer 11a. The second electrode layer 11c may have the same size as the vibration layer 11a, or may have a size which is smaller than the vibration layer 11a. For example, the second electrode layer 11c may have a same shape as the vibration layer 11a, but aspects of the present disclosure are not limited thereto.

According to an aspect of the present disclosure, to prevent electrical short circuit between the first electrode layer 11b and the second electrode layer 11c, each of the first electrode layer 11b and the second electrode layer 11c may be formed at the other portion, except a periphery portion, of the vibration layer 11a. For example, the first electrode layer 11b may be formed at an entire first surface 11s1, other than a periphery portion, of the vibration layer 11a. For example, the second electrode layer 11c may be formed at an entire second surface 11s2, other than a periphery portion, of the vibration layer 11a. For example, a distance between a lateral surface (or a sidewall) of each of the first electrode layer 11b and the second electrode layer 11c and a lateral surface (or a sidewall) of the vibration layer 11a may be at least 0.5 mm or more. For example, the distance between the lateral surface of each of the first electrode layer 11b and the second electrode layer 11c and the lateral surface of the vibration layer 11a may be at least 1 mm or more, but aspects of the present disclosure are not limited thereto.

One or more of the first electrode layer 11b and the second electrode layer 11c according to an aspect of the present disclosure may be formed of a transparent conductive material, a semitransparent conductive material, or an opaque conductive material. For example, the transparent conductive material or the semitransparent conductive material may include indium tin oxide (ITO) or indium zinc oxide (IZO), but aspects of the present disclosure are not limited thereto. The opaque conductive material may include gold (Au), silver (Ag), platinum (Pt), palladium (Pd), molybdenum (Mo), magnesium (Mg), carbon, or silver (Ag) including glass frit, or the like, or may be made of an alloy thereof, but aspects of the present disclosure are not limited thereto. For example, to enhance an electrical characteristic and/or a vibration characteristic of the vibration layer 11a, each of the first electrode layer 11b and the second electrode layer 11c may include silver (Ag) having a low resistivity. For example, the carbon may be a carbon material including carbon black, ketjen black, carbon nanotube, and graphite, but aspects of the present disclosure are not limited thereto.

In the first electrode layer 11b and the second electrode layer 11c including silver (Ag) containing the glass frit, a content of glass frit may be about 1 wt % to about 12 wt %, but aspects of the present disclosure are not limited thereto. The glass frit may include PbO or Bi₂O₃-based material, but aspects of the present disclosure are not limited thereto.

The vibration layer 11a may be polarized (or poling) by a certain voltage applied to the first electrode layer 11b and the second electrode layer 11c in a certain temperature atmosphere or a temperature atmosphere which is changed from a high temperature to a room temperature, but aspects of the present disclosure are not limited thereto. For example, a polarization direction (or a poling direction) formed in the vibration layer 11a may be formed or aligned (or arranged) from the first electrode layer 11b to the second electrode layer 11c, but is not limited thereto and may be formed or aligned (or arranged) from the second electrode layer 11c to the first electrode layer 11b.

The vibration layer 11a may alternately and repeatedly contract and/or expand based on an inverse piezoelectric effect according to a driving signal (or a voice signal) applied to the first electrode layer 11b and the second electrode layer 11c from the outside to vibrate. For example, the vibration layer 11a may vibrate in a vertical direction (or a thickness direction) and a horizontal direction, based on a signal applied to the first electrode layer 11b and the second electrode layer 11c. The vibration layer 11a may be displaced (or vibrated or driven) by contraction and/or expansion in the horizontal direction, and thus, may enhance a vibration characteristic including a sound characteristic and/or a sound pressure level characteristic of the vibration generating part 10 or the vibration apparatus 1.

The vibration layer 11a of the vibration part 11 may have a dielectric constant, and thus, the vibration part 11 may include a capacitance (or capacitor). For example, the vibration part 11 may include a capacitance based on the dielectric constant of the vibration layer 11a between the first electrode layer 11b and the second electrode layer 11c. For example, the vibration generating part 10 may include the vibration part 11 having the capacitance. For example, the capacitance of the vibration part 11 may be expressed as a capacitor or a piezoelectric capacitor in electric circuit, but aspects of the present disclosure are not limited thereto.

The discharge member 30 may be configured to emit or discharge an electric charge accumulated or remaining in the vibration part 11. For example, the discharge member 30 may be configured to emit or discharge an electric charge accumulated (or stored) in the capacitor of the vibration part 11. For example, the discharge member 30 may be configured to be electrically connected between the first electrode layer 11b and the second electrode layer 11c of the vibration part 11. For example, the discharge member 30 may be configured to be electrically connected to the capacitor (or capacitance) of the vibration part 11 in parallel. For example, the discharge member 30 may be a charge emission member, a charge discharge member, a discharge circuit, a charge emission circuit, or a charge discharge circuit, but aspects of the present disclosure are not limited thereto. For example, when the discharge member 30 is in a free-standing state and/or a disconnection state with a driving circuit, the vibration part 11 may be an open preventing circuit which prevents an open circuit from being configured.

According to an aspect of the present disclosure, electric charges by polarization may be balanced in an initial state or a non-deformation state of the vibration part 11 including the polarized (or poling) vibration layer 11a, but in deformation of the vibration part 11, a piezoelectric electric potential and an electric charge may occur in the vibration part 11 due to deformation (or displacement or driving) and an electric charge generated by deformation (or displacement or driving) may be stored (or remain) in the vibration part 11, and thus, depolarization (or de-poling) may occur in the vibration layer 11a due to a residual electric charge of the vibration part 11, causing a reduction in reliability of the vibration part 11 or the vibration apparatus 1. For example, depolarization (or de-poling) of the vibration layer 11a may occur due to electric charge unbalance in the vibration layer 11a caused by deformation (or displacement or driving) of the vibration layer 11a based on various environments such as a low temperature or a high temperature. For example, when a curie temperature Tc of the vibration layer 11a is relatively low, polarization of the vibration layer 11a may be easily depolarized (or de-poling). Accordingly, the discharge member 30 may be configured for removing or discharging a residual electric charge of the vibration layer 11a which causes depolarization (or de-poling).

The discharge member 30 according to an aspect of the present disclosure may be configured at the vibration part 11 or may be embedded at the vibration generating part 10. The discharge member 30 may be configured at the vibration part 11 or may be embedded at the vibration generating part 10 after a polarization (or poling) process of the vibration part 11. For example, the discharge member 30 may be provided to be electrically connected between at least a portion of the first electrode layer 11b and at least a portion of the second electrode layer 11c, at one lateral surface of the vibration layer 11a. Therefore, at least a part of the first electrode layer 11b and at least a part of the second electrode layer 11c may be electrically connected to each other through the discharge member 30, and thus, the discharge member 30 may be electrically connected to a capacitor (or capacitance or a piezoelectric capacitor) of the vibration generating part 10 or the vibration part 11 in parallel.

The discharge member 30 may be configured to have a predetermined resistance value (or an electrical resistance value). For example, a resistance value of the discharge member 30 according to an aspect of the present disclosure may be set to within a range which enables power consumption to be minimized by the discharge member 30, in driving (or vibration) of the vibration apparatus 1. For example, the resistance value of the discharge member 30 may be set to within a range of 0.5% to 5% of total power consumption of the vibration apparatus 1. For example, because power consumption is inversely proportional to a resistance value, power consumption by the discharge member 30 may increase as the resistance value of the discharge member 30 decreases. The discharge member 30 according to an aspect of the present disclosure may be configured to have a resistance value of 100Ω (ohm) or more. For example, the discharge member 30 may be configured to have a resistance value of 100Ω or more and less than 1 MS/(megaohm). For example, when the total power consumption of the vibration apparatus 1 is 10 Wh (watt hour) and the resistance value of the discharge member 30 is 1 kΩ, power consumption by the discharge member 30 may be 0.1 Wh.

The discharge member 30 according to an aspect of the present disclosure may include a conductive material having a predetermined resistance value. The discharge member 30 may include a conductive tape having a resistance value, or may be implemented with a conductive paste having a resistance value. For example, the conductive material or the conductive paste may be configured to have a resistance value (or an electrical resistance value) of 100Ω or more and less than 1 MΩ. The discharge member 30 may configure an RC circuit along with a piezoelectric capacitor of the vibration part 11. For example, the conductive paste of the discharge member 30 may be a resistance, a resistor, a resistance member, or an electrical resistance member, but aspects of the present disclosure are not limited thereto.

As an aspect of the present disclosure, the discharge member 30 including the conductive tape may be attached on at least a portion of the first electrode layer 11b and one lateral surface of the vibration layer 11a, and at least a portion of the second electrode layer 11c, and thus, may electrically connect at least a portion of the first electrode layer 11b with at least a portion of the second electrode layer 11c. For example, the conductive tape of the discharge member 30 may include a first connection portion electrically connected to at least a portion of the first electrode layer 11b, a second connection portion electrically connected to at least a portion of the second electrode layer 11c, and a center portion which is disposed between the first connection portion and the second connection portion to surround one lateral surface of the vibration layer 11a.

As another aspect of the present disclosure, the discharge member 30 implemented with the conductive paste may be continuously coated (or doped or formed) to surround at least a portion of the first electrode layer 11b and one lateral surface of the vibration layer 11a, and at least a portion of the second electrode layer 11c and then may be cured, and thus, may electrically connect at least a portion of the first electrode layer 11b with at least a portion of the second electrode layer 11c.

The conductive paste according to an aspect of the present disclosure may include an adhesive (or a tacky agent) and a conductive particle. For example, the conductive paste may further include a curing agent or a curing agent matrix. The adhesive may include epoxy resin, acrylic resin, silicone resin, or urethane resin, but aspects of the present disclosure are not limited thereto. The conductive particle may be added to the adhesive, and thus, the conductive adhesive layer may have a resistance value (or an electrical resistance value), based on the conductive particle. A volume ratio (or content) of the conductive particle in the conductive adhesive layer may be set to within a range which enables the conductive adhesive layer to have a relatively high resistance value (or electrical resistance value), for example, a resistance value of 100Ω or more and less than 1 MΩ.

The conductive particle according to an aspect of the present disclosure may include one or more of a metal material, a nonmetal material, and a conductive polymer material. The metal material may include one or more of nickel (Ni), silver (Ag), and copper (Cu), but aspects of the present disclosure are not limited thereto. For example, the nonmetal material may include carbon. For example, the carbon may be a carbon material including carbon black, ketjen black, carbon nano tube, and graphite, but aspects of the present disclosure are not limited thereto. The conductive polymer material may include one or more of polyacetylene, polypyrrole, polyaniline, polythiophene, and poly (3, 4-ethylenedioxythiophene) (PEDOT), but aspects of the present disclosure are not limited thereto.

FIG. 4 illustrates a parallel connection structure of a vibration part and a discharge member illustrated in FIGS. 2 and 3. The discharge member 30, as illustrated in FIG. 4, may be electrically connected to a piezoelectric capacitor Ce of the vibration part 11 in parallel, and thus, a residual electric charge Rc of the vibration part 11 may be emitted or discharged until an electrical potential difference between both ends of the vibration part 11 (or the piezoelectric capacitor Ce) is 0 (zero) or a polarization electric charge Pc of the vibration part 11 is balanced. Therefore, the discharge member 30 may minimize or prevent depolarization (or de-poling) of the vibration layer 11a caused by the residual electric charge Rc of the vibration part 11, and thus, a reduction in reliability of the vibration part 11 or the vibration apparatus 1 caused by the residual electric charge of the vibration part 11 may be minimized or prevented. Accordingly, the vibration part 11 or the vibration apparatus 1 according to an aspect of the present disclosure may be improved in reliability, and thus, a lifetime thereof may increase and a sound characteristic and/or a sound pressure level characteristic may be enhanced.

Referring back to FIGS. 1 to 3 the vibration apparatus 1 or a vibration generating part 10 according to an aspect of the present disclosure may further include a first cover member 13 and a second cover member 15.

The first cover member 13 may be disposed at a first surface of the vibration part 11. For example, the first cover member 13 may be configured to cover the first electrode layer 11b of the vibration part 11. For example, the first cover member 13 may be configured to have a greater size than the vibration part 11. The first cover member 13 may be configured to protect the first surface and the first electrode layer 11b of the vibration part 11.

The second cover member 15 may be disposed at a second surface of the vibration part 11. For example, the second cover member 15 may be configured to cover the second electrode layer 11c of the vibration part 11. For example, the second cover member 15 may be configured to have a greater size than the vibration part 11, and may be configured to have a same size as the first cover member 13. The second cover member 15 may be configured to protect the second surface and the second electrode layer 11c of the vibration part 11.

Each of the first cover member 13 and the second cover member 15 according to an aspect of the present disclosure may include one or more material of plastic, fiber, cloth, paper, leather, carbon, rubber, and wood, but aspects of the present disclosure are not limited thereto. For example, each of the first cover member 13 and the second cover member 15 may include the same material or different material. For example, each of the first cover member 13 and the second cover member 15 may be a polyimide film or a polyethylene terephthalate film, but aspects of the present disclosure are not limited thereto.

One or more of the first cover member 13 and the second cover member 15 according to an aspect of the present disclosure may include an adhesive member. For example, one or more of the first cover member 13 and the second cover member 15 may include an adhesive member which is coupled to or attached on the vibration part 11 and a protection member (or a stripping member) which covers or protects the adhesive member. For example, the adhesive member may include an electrical insulation material which has adhesive properties and is capable of compression and decompression. For example, the first cover member 13 may include an adhesive member which is coupled to or attached on the vibration part 11 and a protection member (or a stripping member) which covers or protects the adhesive member.

The first cover member 13 may be connected or coupled to the first surface or the first electrode layer 11b of the vibration part 11 by a first adhesive layer 17. For example, the first cover member 13 may be connected or coupled to the first surface or the first electrode layer 11b of the vibration part 11 by a film laminating process using the first adhesive layer 17.

The second cover member 15 may be connected or coupled to the second surface or the second electrode layer 11c of the vibration part 11 by a second adhesive layer 19. For example, the second cover member 15 may be connected or coupled to the second surface or the second electrode layer 11c of the vibration part 11 by a film laminating process using the second adhesive layer 19.

Each of the first adhesive layer 17 and second adhesive layer 19 according to an aspect of the present disclosure may include an electric insulating material which has adhesiveness and is capable of compression and decompression. For example, each of the first adhesive layer 17 and the second adhesive layer 19 may include an epoxy resin, an acrylic resin, a silicone resin, or a urethane resin, but aspects of the present disclosure are not limited thereto.

Each of the first adhesive layer 17 and second adhesive layer 19 may be configured between the first cover member 13 and the second cover member 15 to surround the vibration part 11. For example, one or more of the first adhesive layer 17 and second adhesive layer 19 may be configured to surround the vibration part 11.

The vibration apparatus 1 according to an aspect of the present disclosure may further include a signal supply member 50.

The signal supply member 50 may be configured to supply the driving signal supplied from a vibration driving circuit to the vibration generating part 10. The signal supply member 50 may be configured to be electrically connected to the vibration part 11 at one side of the vibration generating part 10. The signal supply member 50 may be configured to be electrically connected to the first electrode layer 11b and the second electrode layer 11c of the vibration part 11. A portion of the signal supply member 50 may be between the first cover member 13 and the second cover member 15.

An end portion (or a distal end portion) of the signal supply member 50 may be disposed at or inserted (or accommodated) into a portion between one periphery portion of the first cover member 13 and one periphery portion of the second cover member 15. The one periphery portion of the first cover member 13 and the one periphery portion of the second cover member 15 may accommodate or vertically (or up and down) cover the end portion (or the distal end portion) of the signal supply member 50. Accordingly, the signal supply member 50 may be integrated (or configured as one body) with the vibration generating part 10. For example, the signal supply member 50 may be configured as a signal cable, a flexible cable, a flexible printed circuit cable, a flexible flat cable, a single-sided flexible printed circuit, a single-sided flexible printed circuit board, a flexible multilayer printed circuit, or a flexible multilayer printed circuit board, but aspects of the present disclosure are not limited thereto.

The signal supply member 50 according to an aspect of the present disclosure may include a base member 51 and a plurality of signal lines 53a and 53b. For example, the signal supply member 50 may include a base member 51, a first signal line 53a, and a second signal line 53b.

The base member 51 may include a transparent or opaque plastic material. For example, the base member 51 may be implemented with any one or more of resins including a fluorine resin, a polyimide-based resin, a polyurethane-based resin, a polyester-based resin, a polyethylene-based resin, and a polypropylene-based resin, but aspects of the present disclosure are not limited thereto.

The base member 51 may have a certain width in a first direction X and may extend long along a second direction Y intersecting with the first direction X.

The first and second signal lines 53a and 53b may be disposed at the first surface of the base member 51 in parallel with the second direction Y, and may be spaced apart from each other or electrically separated from each other along the first direction X. The first and second signal lines 53a and 53b may be disposed in parallel to each other at the first surface of the base member 51. For example, the first and second signal lines 53a and 53b may be implemented in a line shape by patterning of a metal layer (or a conductive layer) formed or deposited at the first surface of the base member 51.

The end portions (or the distal end portions) of the first and second signal lines 53a and 53b may be separated from each other, and thus, may be individually curved or bent.

The end portion (or the distal end portion) of the first signal line 53a may be electrically connected to the first electrode layer 11b of the vibration part 11. For example, the end portion of the first signal line 53a may be electrically connected to at least a portion of the first electrode layer 11b of the vibration part 11 at one periphery portion of the first cover member 13. For example, the end portion (or the distal end portion) of the first signal line 53a may be electrically and directly connected to at least a portion of the first electrode layer 11b of the vibration part 11. For example, the end portion (or the distal end portion) of the first signal line 53a may be directly connected to or directly contact the first electrode layer 11b of the vibration part 11. For example, the end portion of the first signal line 53a may be electrically connected to the first electrode layer 11b by a conductive double-sided tape. Accordingly, the first signal line 53a may supply a first driving signal, supplied from a vibration driving circuit, to the first electrode layer 11b of the vibration part 11.

The end portion (or the distal end portion) of the second signal line 53b may be electrically connected to the second electrode layer 11c of the vibration part 11. For example, the end portion of the second signal line 53b may be electrically connected to at least a portion of the second electrode layer 11c of the vibration part 11 at one periphery portion of the second cover member 15. For example, the end portion (or the distal end portion) of the second signal line 53b may be electrically and directly connected to at least a portion of the second electrode layer 11c of the vibration part 11. For example, the end portion (or the distal end portion) of the second signal line 53b may be directly connected to or directly contact the second electrode layer 11c of the vibration part 11. For example, the end portion of the second signal line 53b may be electrically connected to the second electrode layer 11c by a conductive double-sided tape. Accordingly, the second signal line 53b may supply a second driving signal, supplied from a vibration driving circuit, to the second electrode layer 11c of the vibration part 11.

The signal supply member 50 according to an aspect of the present disclosure may further include an insulation layer 55.

The insulation layer 55 may be disposed at the first surface of the base member 51 to cover each of the first signal line 53a and the second signal line 53b other than the end portion (or one side) of the signal supply member 50. The insulation layer 55 may be a protective layer, a coverlay, a coverlay layer, a cover film, a cover insulation film, or solder mask, but aspects of the present disclosure are not limited thereto.

An end portion (or one side) of the signal supply member 50 including an end portion (or one side) of the base member 51 may be inserted (or accommodated) between the first surface of the vibration part 11 and the first cover member 13 and may be inserted (or accommodated) and fixed between the first surface of the vibration part 11 and the first cover member 13 by the first adhesive layer 17. For example, the end portion (or one side) of the signal supply member 50 inserted between the first surface of the vibration part 11 and the first cover member 13 may be inserted (or accommodated) and fixed between the first surface of the vibration part 11 and the first cover member 13 by a film laminating process which uses the first adhesive layer 17 and/or the second adhesive layer 19. Accordingly, the end portion (or one side) of the first signal line 53a may be maintained with being electrically connected to the first electrode layer 11b of the vibration part 11, and the end portion (or one side) of the second signal line 53b may be maintained with being electrically connected to the second electrode layer 11c of the vibration part 11. In addition, the end portion (or one side) of the signal supply member 50 may be inserted (or accommodated) and fixed between the first surface of the vibration part 11 and the first cover member 13, and thus, a contact defect between the vibration part 11 and the signal supply member 50 caused by the movement of the signal supply member 50 may be prevented.

In the signal supply member 50 according to an aspect of the present disclosure, each of the end portion (or one side) of the base member 51 and the end portion (or one side) of the insulation layer 55 may be removed. For example, each of the end portion of the first signal line 53a and the end portion of the second signal line 53b may be exposed at the outside without being supported or covered by the end portion of the base member 51 and the end portion (or one side) 55a of the insulation layer 55. For example, the end portion of the first signal line 53a and the end portion of the second signal line 53b may protrude (or extend) to have a certain length from an end 51e of the base member 51 or an end 55a of the insulation layer 55. Accordingly, each of the end portion of the first signal line 53a and the end portion of the second signal line 53b may be individually or independently bent.

Each of the first and second signal lines 53a and 53b may be disposed between only the base member 51 and the insulation layer 55. The end portion (or one side) of the first signal line 53a which is not supported by each of an end portion (or one side) of the base member 51 and the end portion (or one side) 55a of the insulation layer 55 may be directly connected to or directly contact the first electrode layer 11b of the vibration part 11. The end portion (or one side) of the second signal line 53b which is not supported by each of an end portion (or one side) of the base member 51 and the end portion (or one side) 55a of the insulation layer 55 may be directly connected to or directly contact the second electrode layer 11c of the vibration part 11.

According to an aspect of the present disclosure, a portion of the signal supply member 50 may be disposed or inserted (or accommodated) between the vibration part 11 and the first cover member 13, and thus, the signal supply member 50 may be integrated (or configured) as one body with the vibration generating part 10. Accordingly, the signal supply member 50 and the vibration generating part 10 may be configured as one part (or an element or a component), and thus, an effect of uni-materialization may be obtained.

In the vibration apparatus 1 according to an aspect of the present disclosure, the first signal line 53a and the second signal line 53b of the signal supply member 50 may be integrated (or configured) as one body with the vibration generating part 10, and thus, a soldering process for an electrical connection between the vibration generating part 10 and the signal supply member 50 may not be needed, whereby a structure and a manufacturing process of the vibration apparatus 1 may be simplified, and thus, a hazard process may be improved.

The vibration apparatus 1 according to an aspect of the present disclosure may include the discharge member 30 for removing or discharging the residual electric charge of the vibration part 11, and thus, a reduction in reliability caused by the residual electric charge of the vibration part 11 may be minimized or prevented, thereby improving reliability, increasing lifetime, and enhancing a sound characteristic and/or a sound pressure level characteristic.

FIG. 5 illustrates the conductive tape of the discharge member illustrated in FIGS. 1 and 3.

Referring to FIG. 5, a discharge member 30 according to an aspect of the present disclosure may include a conductive tape 31.

The conductive tape 31 may include a base film 31a and a conductive adhesive layer 31b.

The base film 31a may include a transparent or opaque plastic material. For example, the base film 31a may be configured as any one or more of synthetic resins including a fluorine resin, a polyimide-based resin, a polyurethane-based resin, a polyester-based resin, a polyethylene-based resin, and a polypropylene-based resin, but aspects of the present disclosure are not limited thereto.

The conductive adhesive layer 31b may be supported by the base film 31a. The conductive adhesive layer 31b may be configured to have a predetermined resistance value (or an electrical resistance value). The conductive adhesive layer 31b may include an adhesive (or a tacky agent) 31b1 and a conductive particle 31b2. For example, the conductive adhesive layer 31b may further include a curing agent or a curing agent matrix. For example, the conductive adhesive layer 31b may be a resistance, a resistor, a resistance member, or an electrical resistance member, but aspects of the present disclosure are not limited thereto.

The adhesive 31b1 may include epoxy resin, acrylic resin, silicone resin, or urethane resin, but aspects of the present disclosure are not limited thereto.

The conductive particle 31b2 may be added to the adhesive 31b1, and thus, the conductive adhesive layer 31b may have a resistance value (or an electrical resistance value) by the conductive particle 31b2. A volume ratio (or content) of the conductive particle in the conductive adhesive layer 31b may be set to within a range which enables the conductive adhesive layer 31b to have a relatively high resistance value (or electrical resistance value), for example, a resistance value of 100Ω or more and less than 1 MΩ.

The conductive particle 31b2 according to an aspect of the present disclosure may include one or more of a metal material, a nonmetal material, and a conductive polymer material.

The metal material of the conductive particle 31b2 may include one or more of nickel (Ni), silver (Ag), and copper (Cu), but aspects of the present disclosure are not limited thereto.

The nonmetal material of the conductive particle 31b2 may include carbon. For example, the carbon may be a carbon material including carbon black, ketjen black, carbon nano tube, and graphite, but aspects of the present disclosure are not limited thereto.

The conductive polymer material of the conductive particle 31b2 may include one or more of polyacetylene, polypyrrole, polyaniline, polythiophene, and poly (3, 4-ethylenedioxythiophene) (PEDOT), but aspects of the present disclosure are not limited thereto.

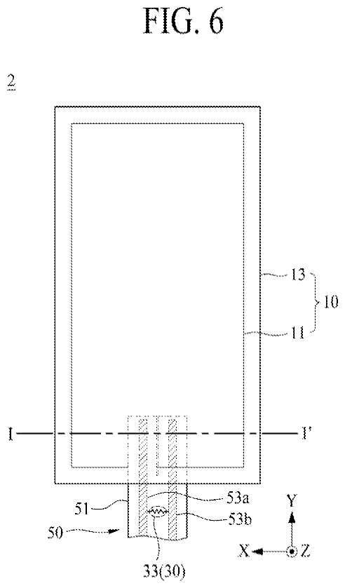

FIG. 6 illustrates a vibration apparatus according to another aspect of the present disclosure. FIG. 6 illustrates an aspect where a discharge member 30 is modified in the vibration apparatus 1 described with reference to FIGS. 1 to 5. In the vibration apparatus 2 according to another aspect of the present disclosure, a discharge member 30 may be configured in a signal supplying member 50, and for this reason, the vibration apparatus 2 according to another aspect of the present disclosure may differ from the vibration apparatus 1 according to an aspect of the present disclosure. Hereinafter, in describing the vibration apparatus 2 according to another aspect of the present disclosure, elements differing from the elements of the vibration apparatus 1 according to the aspect of the present disclosure will be mainly described. A cross-sectional surface taken along line I-I′ illustrated in FIG. 6 is illustrated in FIG. 2.

Referring to FIG. 6, in a vibration apparatus 2 according to another aspect of the present disclosure, a discharge member 30 may be configured at a signal supply member 50.

The discharge member 30 may be electrically connected between a first signal line 53a and a second signal line 53b, which are configured at the signal supply member 50. The discharge member 30 may be mounted (or disposed) on a base member 51 of the signal supply member 50 and may be electrically connected between the first signal line 53a and the second signal line 53b, and thus, may be electrically connected to a capacitor (or capacitance) of a vibration part 11 in parallel. The discharge member 30 may be disposed at a same layer as the first signal line 53a and the second signal line 53b and may be covered by an insulation layer, but aspects of the present disclosure are not limited thereto.

The discharge member 30 according to another aspect of the present disclosure may be configured at the signal supply member 50 in a manufacturing process of the signal supply member 50.

The discharge member 30 may include a resistance member 33 which is configured at the signal supply member 50 to be electrically connected between the first signal line 53a and the second signal line 53b. For example, to remove or discharge a residual electric charge of the vibration part 11, as described above with reference to FIGS. 1 to 5, the resistance member 33 may be configured to have a resistance value of 100Ω or more and less than 1 MΩ.

The resistance member 33 according to an aspect of the present disclosure may be a resistance, an electrical resistance, a resistor, an electrical resistor, or a resistance element, which has a resistance value of 100Ω or more and less than 1 MΩ, but aspects of the present disclosure are not limited thereto.

The resistance member 33 according to another aspect of the present disclosure may include a conductive tape which is configured at the signal supply member 50 to be electrically connected between the first signal line 53a and the second signal line 53b, or may be implemented by a conductive paste. Except for that each of the conductive tape and the conductive paste is configured at the signal supply member 50 to be electrically connected between the first signal line 53a and the second signal line 53b, each of the conductive tape and the conductive paste may be substantially a same as each of the conductive tape and the conductive paste described above with reference to FIGS. 1 to 5, and thus, repeated descriptions thereof are omitted.

The signal supply member 50 including the discharge member 30 may be electrically connected to the vibration part 11 after a polarization (or poling) process of the vibration part 11. Therefore, according to another aspect of the present disclosure because the discharge member 30 is configured at the signal supply member 50, the polarization (or poling) process of the vibration part 11 may be performed without being affected by the discharge member 30.

The vibration apparatus 2 according to another aspect of the present disclosure may have a same effect as the vibration apparatus 1 according to an aspect of the present disclosure described above with reference to FIGS. 1 to 5, and thus, repeated descriptions thereof are omitted.

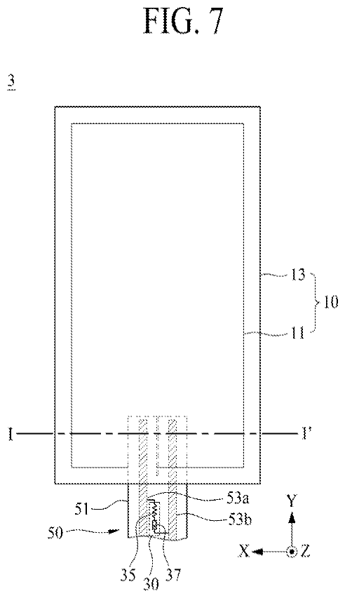

FIG. 7 illustrates a vibration apparatus according to another aspect of the present disclosure. FIG. 7 illustrates an aspect where a discharge member 30 is modified in the vibration apparatus 2 described with reference to FIG. 6. Hereinafter, in describing the vibration apparatus 3 according to another aspect of the present disclosure, elements differing from the elements of the vibration apparatus 2 according to the aspect of the present disclosure will be mainly described. A cross-sectional surface taken along line I-I′ illustrated in FIG. 7 is illustrated in FIG. 2.

Referring to FIG. 7, in a vibration apparatus 3 according to another aspect of the present disclosure, a discharge member 30 may include a resistance member 35 and a switch member 37, which are configured at a signal supply member 50. For example, the discharge member 30 may include the resistance member 35 and the switch member 37, which are serially connected to each other.

The resistance member 35 may be electrically connected to any one of a first signal line 53a and a second signal line 53b, which are configured at the signal supply member 50. The resistance member 35 may be mounted (or disposed) on a base member 51 of the signal supply member 50 to be electrically connected to any one of the first signal line 53a and the second signal line 53b. For example, the resistance member 35 may be electrically and directly connected to the first signal line 53a. For example, the resistance member 35 may be include a first terminal (or one end or one side) and a second terminal (or the other end or the other side). The first terminal (or one end or one side) may be electrically and directly connected to the first signal line 53a.

To remove or discharge a residual electric charge of the vibration part 11, as described above with reference to FIGS. 1 to 5, the resistance member 35 may be configured to have a resistance value of 100Ω or more. For example, the resistance member 35 may be configured to have a resistance value of 100Ω or more and less than 1 MΩ.

The resistance member 35 according to an aspect of the present disclosure may be a resistance, an electrical resistance, a resistor, an electrical resistor, or a resistance element, which has a resistance value of 100Ω or more and less than 1 MΩ, but aspects of the present disclosure are not limited thereto.

The resistance member 35 according to another aspect of the present disclosure may include a conductive tape which is configured at the signal supply member 50 to be electrically connected between the first signal line 53a and the second signal line 53b, or may be implemented by a conductive paste. For example, the conductive tape or the conductive paste may include an end (or one side) and the other end (or other side). For example, the end (or one side) of the conductive tape or the conductive paste may be electrically and directly connected to the first signal line 53a. Except for that each of the conductive tape and the conductive paste is configured at the signal supply member 50 to be electrically connected between the first signal line 53a and the second signal line 53b, each of the conductive tape and the conductive paste may be substantially a same as each of the conductive tape and the conductive paste described above with reference to FIGS. 1 to 5, and thus, repeated descriptions thereof are omitted.

The switch member 37 may be electrically connected between the resistance member 35 and the signal line 53b, which is not connected to the resistance member 35, of the first signal line 53a and the second signal line 53b. For example, the switch member 37 may be mounted (or disposed) on a base member 51 of the signal supply member 50 to be electrically connected between the second terminal (or the other end or the other side) of the resistance member 35 and the second signal line 53b. For example, the resistance member 35 and the switch member 37 may be electrically and serially connected between the first signal line 53a and the second signal line 53b, and thus, may be electrically connected to a capacitor (or capacitance) of a vibration part 11 in parallel.

The switch member 37 according to an aspect of the present disclosure may be a passive switch element or a dip switch, which has an on and off function. The switch member 37 may be fixed to an on state or an off state by a user. For example, when a polarization (or poling) process on the vibration part 11 is performed in a state where the signal supply member 50 is electrically connected to the vibration part 11 or the vibration generating part 10, the switch member 37 may be changed to an off state by the user. Accordingly, the polarization (or poling) process on the vibration part 11 may be performed without being affected by the discharge member 30. For example, the switch member 37 may maintain an off state in only the polarization (or poling) process on the vibration part 11 and may be fixed to an on state after the polarization (or poling) process on the vibration part 11.

When the switch member 37 is in an on state, the discharge member 30 according to another aspect of the present disclosure may be electrically connected between the first signal line 53a and the second signal line 53b, and thus, may remove or discharge a residual electric charge of the vibration part 11. For example, when the switch member 37 is in an on state, the resistance member 35 of the discharge member 30 may be electrically connected between the first signal line 53a and the second signal line 53b, and thus, may remove or discharge the residual electric charge of the vibration part 11.

The vibration apparatus 3 according to another aspect of the present disclosure may have a same effect as the vibration apparatus 1 according to an aspect of the present disclosure described above with reference to FIGS. 1 to 5, and thus, repeated descriptions thereof are omitted.

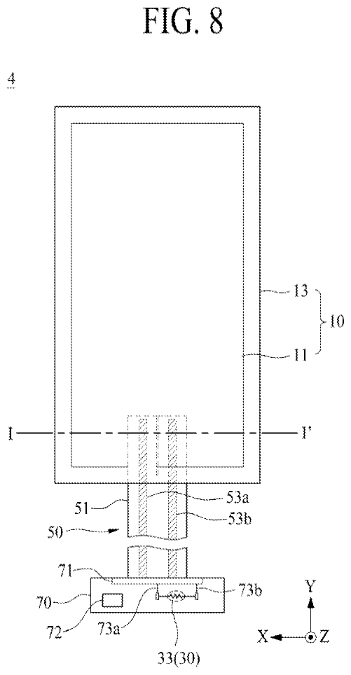

FIG. 8 illustrates a vibration apparatus according to another aspect of the present disclosure. FIG. 8 illustrates an aspect where a printed circuit board 70 is additionally configured in the vibration apparatus 1 described with reference to FIGS. 1 to 5 and a discharge member 30 is modified. In the vibration apparatus 4 according to another aspect of the present disclosure, a discharge member 30 may be configured in a printed circuit board 70, and for this reason, the vibration apparatus 4 according to another aspect of the present disclosure may differ from the vibration apparatus 1 according to an aspect of the present disclosure. Hereinafter, in describing the vibration apparatus 4 according to another aspect of the present disclosure, elements differing from the elements of the vibration apparatus 1 according to the aspect of the present disclosure will be mainly described. A cross-sectional surface taken along line I-I′ illustrated in FIG. 8 is illustrated in FIG. 2.

Referring to FIGS. 2 to 8, a vibration apparatus 4 according to another aspect of the present disclosure may further include a printed circuit board (PCB) 70.

The PCB 70 may be configured to be connected to the signal supply member 50.

The PCB 70 may include a connector 71 which is electrically connected to the signal supply member 50.

The connector 71 may include a first signal terminal and a second signal terminal. The first signal terminal may be electrically connected to a first signal line 53a of the signal supply member 50. The second signal terminal may be electrically connected to a second signal line 53b of the signal supply member 50.

The discharge member 30 may be configured at the PCB 70. For example, the discharge member 30 may be configured at the PCB 70 to be electrically connected between the first signal line 53a and the second signal line 53b configured at the signal supply member 50. For example, the discharge member 30 may be configured at the PCB 70 to be electrically connected between the first signal terminal and the second signal terminal of the connector 71 configured at the PCB 70 and may be electrically connected between the first signal line 53a and the second signal line 53b.

The PCB 70 may further include a first conductive line 73a electrically connected to the first signal line 53a of the signal supply member 50 and a second conductive line 73b electrically connected to the second signal line 53b of the signal supply member 50. The first conductive line 73a may be electrically connected to the first signal terminal of the connector 71, or may extend (or protrude) from the first signal terminal of the connector 71. The second conductive line 73b may be electrically connected to the second signal terminal of the connector 71, or may extend (or protrude) from the second signal terminal of the connector 71.

The discharge member 30 may be electrically connected between the first conductive line 73a and the second conductive line 73b, which are configured at the PCB 70. The discharge member 30 may be mounted (or disposed) on the PCB 70 and may be electrically connected between the first conductive line 73a and the second conductive line 73b, and thus, may be electrically connected to a capacitor (or capacitance) of a vibration part 11 in parallel. The discharge member 30 may be disposed at a same layer as the first conductive line 73a and the second conductive line 73b, but aspects of the present disclosure are not limited thereto.

The discharge member 30 according to another aspect of the present disclosure may be configured at the PCB 70 in a manufacturing process of the PCB 70.

The discharge member 30 may include a resistance member 33 which is configured at the PCB 70 to be electrically connected between the first conductive line 73a and the second conductive line 73b. For example, to remove or discharge a residual electric charge of the vibration part 11, as described above with reference to FIGS. 1 to 5, the resistance member 33 may be configured to have a resistance value of 100Ω or more and less than 1 MΩ. Except for that a resistance member 33 is configured on the PCB 70 to be electrically connected between the first conductive line 73a and the second conductive line 73b, the resistance member 33 may be a same as or substantially a same as the resistance member 33 described above with reference to FIG. 6, and thus, like reference numerals refer to like elements and repeated descriptions thereof are omitted. Thus, descriptions of the resistance member 33 described above with reference to FIG. 6 may be included in descriptions of the resistance member 33 illustrated in FIG. 8.

The PCB 70 including the discharge member 30 may be electrically connected to the vibration part 11 after a polarization (or poling) process of the vibration part 11. Therefore, according to another aspect of the present disclosure because the discharge member 30 is configured at the PCB 70, the polarization (or poling) process of the vibration part 11 may be performed without being affected by the discharge member 30.

The vibration apparatus 4 according to another aspect of the present disclosure may further include a vibration driving circuit 72 which is electrically connected to the PCB 70. The vibration driving circuit 72 may be mounted (or disposed) at the PCB 70, but aspects of the present disclosure are not limited thereto.

The vibration driving circuit 72 may generate and output a driving signal (or a sound signal or a vibration signal) for vibrating (or displacing or driving) a vibration generating part 10 or a vibration part 11, based on a sound source signal (or sound source data) input from a host apparatus (or a host driving circuit). The driving signal may include a positive driving signal (or a first driving signal) and a negative driving signal (or a second driving signal). The positive driving signal may be supplied to a first electrode layer 11b of a vibration generating part 10 or a vibration part 11 through the PCB 70 and the connector 71 and through the first signal line 53a of the signal supply member 50. The negative driving signal may be supplied to a second electrode layer 11c of the vibration generating part 10 or the vibration part 11 through the PCB 70 and the connector 71 and through the second signal line 53b of the signal supply member 50. For example, the vibration driving circuit 72 may include an amplification circuit which amplifies the sound source signal to generate the driving signal.

The vibration apparatus 4 according to another aspect of the present disclosure may have a same effect as the vibration apparatus 1 according to an aspect of the present disclosure described above with reference to FIGS. 1 to 5, or the vibration apparatus 2 according to another aspect of the present disclosure described above with reference to FIG. 6, and thus, repeated descriptions thereof are omitted.

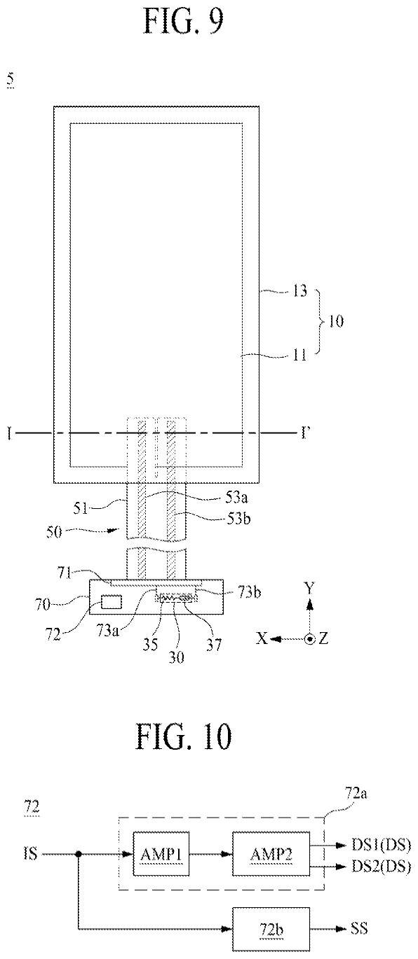

FIG. 9 illustrates a vibration apparatus according to another aspect of the present disclosure. FIG. 9 illustrates an aspect where a discharge member 30 is modified in the vibration apparatus 4 described with reference to FIG. 8. Hereinafter, in describing the vibration apparatus 5 according to another aspect of the present disclosure, elements differing from the elements of the vibration apparatus 4 according to another aspect of the present disclosure will be mainly described. A cross-sectional surface taken along line I-I′ illustrated in FIG. 9 is illustrated in FIG. 2.

Referring to FIG. 9, in a vibration apparatus 5 according to another aspect of the present disclosure, a discharge member 30 may include a resistance member 35 and a switch member 37, which are configured at a printed circuit board (PCB) 70. For example, the discharge member 30 may include the resistance member 35 and the switch member 37, which are serially connected to each other. For example, the discharge member 30 may include the resistance member 35 and the switch member 37 which are serially connected to each other between a first conductive line 73a and a second conductive line 73b configured at the PCB 70.

The resistance member 35 may be electrically connected to any one of the first conductive line 73a and the second conductive line 73b, which are configured at the PCB 70. For example, the resistance member 35 may be electrically and directly connected to the first conductive line 73a. For example, the resistance member 35 may be include a first terminal (or one end or one side) and a second terminal (or the other end or the other side). The first terminal (or one end or one side) may be electrically and directly connected to the first conductive line 73a.

The resistance member 35 may be a same as or substantially a same as the resistance member 35 described above with reference to FIG. 8, and thus, like reference numerals refer to like elements and repeated descriptions thereof are omitted. Accordingly, descriptions of the resistance member 35 described above with reference to FIG. 8 may be included in descriptions of a resistance member 35 illustrated in FIG. 9.

The switch member 37 may be electrically connected between the resistance member 35 and the conductive line 73b, which is not connected to the resistance member 35, of the first conductive line 73a and the second conductive line 73b. For example, the switch member 37 may be mounted (or disposed) on the PCB 70 to be electrically connected between the second terminal (or the other end or the other side) of the resistance member 35 and the second conductive line 73b. For example, the resistance member 35 and the switch member 37 may be electrically and serially connected between the first conductive line 73a and the second conductive line 73b, and thus, may be electrically connected to a capacitor (or capacitance) of a vibration part 11 in parallel.

The switch member 37 according to an aspect of the present disclosure may be a passive switch element or a dip switch, which has an on and off function. The switch member 37 may be fixed to an on state or an off state by a user. For example, when a polarization (or poling) process on the vibration part 11 is performed in a state where the PCB 70 is electrically connected to the vibration part 11 or the vibration generating part 10 through a signal supply member 50, the switch member 37 may be changed to an off state by the user. Accordingly, the polarization (or poling) process on the vibration part 11 may be performed without being affected by the discharge member 30. For example, the switch member 37 may maintain an off state in only the polarization (or poling) process on the vibration part 11 and may be fixed to an on state after the polarization (or poling) process on the vibration part 11.

When the switch member 37 is in an on state, the discharge member 30 according to another aspect of the present disclosure may be electrically connected between the first conductive line 73a and the second conductive line 73b, and thus, may remove or discharge a residual electric charge of the vibration part 11. For example, when the switch member 37 is in an on state, the resistance member 35 of the discharge member 30 may be electrically connected between the first conductive line 73a and the second conductive line 73b, and thus, may remove or discharge the residual electric charge of the vibration part 11.

The vibration apparatus 5 according to another aspect of the present disclosure may have a same effect as the vibration apparatus 1 according to an aspect of the present disclosure described above with reference to FIGS. 1 to 5, or the vibration apparatus 4 according to another aspect of the present disclosure described above with reference to FIG. 8, and thus, repeated descriptions thereof are omitted.

FIG. 10 illustrates a vibration driving circuit according to an aspect of the present disclosure. FIG. 10 illustrates the vibration driving circuit illustrated in FIGS. 8 and 9.

Referring to FIGS. 8 to 10, a vibration driving circuit 72 according to an aspect of the present disclosure may include an amplification circuit 72a.

The amplification circuit 72a may generate and output a driving signal (or a sound signal or a vibration signal) DS for vibrating (or displacing or driving) the vibration generating part 10 or the vibration part 11, based on a sound source signal (or sound source data) IS input from the host apparatus (or the host driving circuit). For example, the driving signal DS may include a positive driving signal (or a first driving signal) DS1 and a negative driving signal (or a second driving signal) DS2. The positive driving signal DS1 may be supplied to a first electrode layer 11b of a vibration generating part 10 or a vibration part 11 through the PCB 70 and the connector 71 and through the first signal line 53a of the signal supply member 50. The negative driving signal may be supplied to a second electrode layer 11c of the vibration generating part 10 or the vibration part 11 through the PCB 70 and the connector 71 and through the second signal line 53b of the signal supply member 50. Accordingly, the vibration generating part 10 or the vibration part 11 may be vibrated (or displaced or driven) by the first and second driving signals DS1 and DS2 to generate or output a vibration or a sound.

The amplification circuit 72a according to an aspect of the present disclosure may include a preamplifier AMP1 and a main amplifier AMP2.

The preamplifier AMP1 may primarily amplify the sound source signal (or sound source data) IS input to the vibration driving circuit 72 to generate an amplification signal.

The main amplifier AMP2 may additionally amplify the amplification signal supplied from the preamplifier AMP1 to generate the driving signal DS and may output the generated driving signal DS to the signal supply member 50 through the PCB 70 and the connector 71.

The vibration driving circuit 72 according to an aspect of the present disclosure may further include a switching signal generating circuit 72b. For example, when the vibration driving circuit 72 includes the switching signal generating circuit 72b, the switch member 37 illustrated in FIG. 9 may be replaced with a transistor. For example, the transistor of the switch member 37 may be mounted (or disposed) on the PCB 70 to be electrically connected between the second terminal (or the other end or the other side) of the resistance member 35 and the second conductive line 73b. The transistor of the switch member 37 may be switched (turned on or turned off) or controlled by the vibration driving circuit 72 or the switching signal generating circuit 72b.

The switching signal generating circuit 72b according to an aspect of the present disclosure may calculate driving information about the vibration apparatus 5, based on the sound source signal (or sound source data) IS supplied from the amplification circuit 72a, and may generate a switching signal SS, based on the calculated driving information. The switch signal SS may be supplied to a gate electrode of the switch member 37, and thus, may switch (turn on or turn off) the transistor of the switch member 37. For example, the driving information about the vibration apparatus 5 may be a driving time of the vibration apparatus 5, but aspects of the present disclosure are not limited thereto. For example, the switching signal generating circuit 72b may supply the switching signal SS having a gate on voltage level to a gate electrode of the transistor of the switch member 37 whenever the driving information about the vibration apparatus 5 is greater than a predetermined driving period-based reference value, and thus, may turn on the transistor of the switch member 37. For example, when the transistor of the switch member 37 is in a turn-on state, the resistance member 35 of the discharge member 30 may be electrically connected between the first conductive line 73a and the second conductive line 73b, and thus, a residual electric charge of the vibration part 11 may be removed or discharged.

When a polarization (or poling) process on the vibration part 11 is performed in a state where the PCB 70 is electrically connected to the vibration part 11 or the vibration generating part 10 through the signal supply member 50, the switching signal generating circuit 72b may supply the switching signal SS having a gate off voltage level to the gate electrode of the transistor of the switch member 37, and thus, may turn off the transistor of the switch member 37. For example, when the transistor of the switch member 37 is in a turn-off state, the resistance member 35 of the discharge member 30 may be electrically disconnected from the first conductive line 73a and the second conductive line 73b, and thus, the vibration part 11 may configure an open circuit, whereby the polarization (or poling) process on the vibration part 11 may be performed without being affected by the discharge member 30. For example, the transistor of the switch member 37 may maintain a turn-off state in only the polarization (or poling) process on the vibration part 11, based on control by the switching signal generating circuit 72b, and may be periodically turned on for removing or discharging the residual electric charge of the vibration part 11 after the polarization (or poling) process on the vibration part 11.

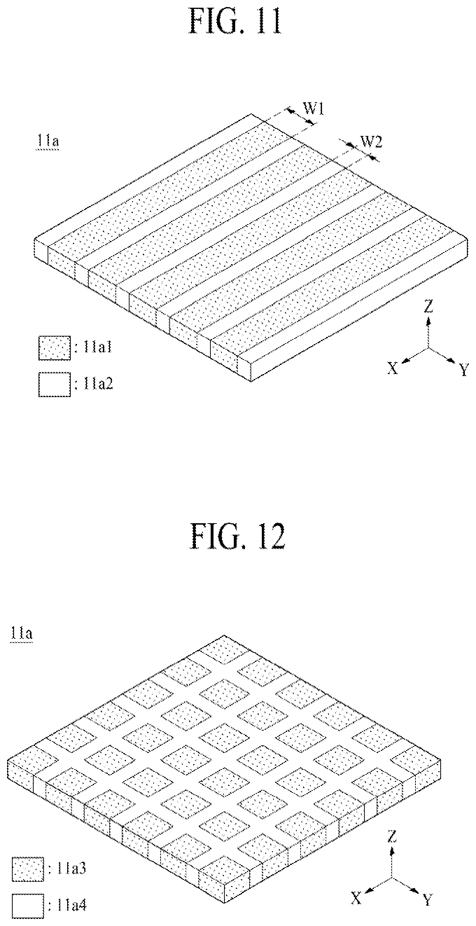

FIG. 11 illustrates a vibration layer according to another aspect of the present disclosure. FIG. 11 illustrates another aspect of a vibration layer illustrated in FIGS. 2 to 4.

Referring to FIGS. 2 and 11, the vibration layer 11a according to another aspect of the present disclosure may include a plurality of first portions 11a1 and a plurality of second portions 11a2. For example, the plurality of first portions 11a1 and the plurality of second portions 11a2 may be alternately and repeatedly arranged along a first direction X (or a second direction Y). For example, the first direction X may be a widthwise direction of the vibration layer 11a, the second direction Y may be a lengthwise direction of the vibration layer 11a intersecting with the first direction X, but aspects of the present disclosure are not limited thereto. For example, the first direction X may be the lengthwise direction of the vibration layer 11a, and the second direction Y may be the widthwise direction of the vibration layer 11a.

Each of the plurality of first portions 11a1 may include an inorganic material having a piezoelectric effect (or a piezoelectric characteristic). For example, each of the plurality of first portions 11a1 may include a piezoelectric material, a composite piezoelectric material, or an electroactive material. For example, each of the plurality of first portions 11a1 may be an inorganic portion, an inorganic material portion, a piezoelectric portion, a piezoelectric material portion, or an electroactive portion, but aspects of the present disclosure are not limited thereto.

According to an aspect of the present disclosure, each of the plurality of first portions 11a1 may have a first width W1 parallel to the first direction X and may extend along a second direction Y intersecting the first direction X. Each of the plurality of first portions 11a1 may include a piezoelectric material which is be substantially a same as the vibration layer 11a described above with reference to FIGS. 2 and 3, and thus, repeated descriptions thereof are omitted.

Each of the plurality of second portion 11a2 may be disposed between the plurality of first portions 11a1. For example, each of the plurality of first portion 11a1 may be disposed between two adjacent second portions 11a2 of the plurality of second portion 11a2. Each of the plurality of second portions 11a2 may have a second width W2 parallel to the first direction X (or the second direction Y) and may extend along the second direction Y (or the first direction X). The first width W1 may be a same as or different from the second width W2. For example, the first width W1 may be greater than the second width W2. For example, the first portion 11a1 and the second portion 11a2 may include a line shape or a stripe shape which has the same size or different sizes.

Each of the plurality of second portions 11a2 may be configured to fill a gap between two adjacent first portions of the plurality of first portions 11a1. Each of the plurality of second portions 11a2 may be configured to fill a gap between two adjacent first portions of the plurality of first portions 11a1 and may be connected to or attached at a side surface of the first portion 11a1 adjacent thereto. According to an aspect of the present disclosure, each of the plurality of first portions 11a1 and the plurality of second portions 11a2 may be disposed (or arranged) at the same plane (or the same layer) in parallel with each other. Therefore, the vibration layer 11a may extend by a desired size or length based on the side coupling (or connection) of the first portion 11a1 and the second portion 11a2.

According to an aspect of the present disclosure, each of the plurality of second portions 11a2 may absorb an impact applied to the first portions 11a1, and thus, may enhance the total durability of the first portions 11a1 and provide flexibility to the vibration layer 11a. Each of the plurality of second portions 11a2 may include an organic material having a flexible characteristic. For example, each of the plurality of second portions 11a2 may include one or more of an epoxy-based polymer, an acrylic-based polymer, and a silicone-based polymer, but aspects of the present disclosure are not limited thereto. For example, each of the plurality of second portions 11a2 may be an organic portion, an organic material portion, an adhesive portion, an elastic portion, a bending portion, a damping portion, or a flexible portion, but aspects of the present disclosure are not limited thereto.

A first surface of each of the plurality of first portions 11a1 and the plurality of second portions 11a2 may be connected to the first electrode layer 11b in common. A second surface of each of the plurality of first portions 11a1 and the plurality of second portions 11a2 may be connected to the second electrode layer 11c in common.

The plurality of first portions 11a1 and the plurality of second portion 11a2 may be disposed on (or connected to) the same plane, and thus, the vibration layer 11a according to another aspect of the present disclosure may have a single thin film-type. Accordingly, the vibration part 11 or the vibration generating part 10 including the vibration layer 11a according to another aspect of the present disclosure may be vibrated in a vertical direction by the first portions 11a1 having a vibration characteristic and may be bent in a curved shape by the second portions 11a2 having flexibility.

FIG. 12 illustrates a vibration layer according to another aspect of the present disclosure. FIG. 12 illustrates another aspect of a vibration layer illustrated in FIGS. 2 to 4.

Referring to FIGS. 2 and 12, a vibration layer 11a according to another aspect of the present disclosure may include a plurality of first portions 11a3, and a second portion 11a4 disposed between the plurality of first portions 11a3.

Each of the plurality of first portions 11a3 may be disposed to be spaced apart from one another along each of the first direction X and the second direction Y. For example, each of the plurality of first portions 11a3 may have a six-sided object shape (or a hexahedral shape) having the same size and may be disposed in a lattice shape, but aspects of the present disclosure are not limited thereto. For example, each of the plurality of first portions 11a3 may have a circular shape plate, an oval shape plate, or a polygonal shape plate, which have the same size as each other, but aspects of the present disclosure are not limited thereto.

Each of the plurality of first portions 11a3 may include a piezoelectric material which is be substantially a same as the first portion 11a1 described above with reference to FIG. 11, and thus, repeated descriptions thereof are omitted.

The second portion 11a4 may be disposed between the plurality of first portions 11a3 along each of the first direction X and the second direction Y. The second portion 11a4 may be configured to fill a gap between two adjacent first portions 11a3 or to surround each of the plurality of first portions 11a3, and thus, the second portion 11a4 may be connected to or attached on the first portion 11a3 adjacent thereto. The second portion 11a4 may include an organic material which is be substantially a same as the second portions 11a2 described above with reference to FIG. 11, and thus, repeated descriptions thereof are omitted.

A first surface of each of the plurality of first portions 11a3 and the second portion 11a4 may be connected to the first electrode layer 11b in common. A second surface of each of the plurality of first portions 11a3 and the second portion 11a4 may be connected to the second electrode layer 11c in common.

The plurality of first portions 11a3 and the second portion 11a4 may be disposed on (or connected to) the same plane, and thus, the vibration layer 11a according to another aspect of the present disclosure may have a single thin film-type. Accordingly, the vibration part 11 or the vibration generating part 10 including the vibration layer 11a according to another aspect of the present disclosure may be vibrated in a vertical direction by the first portions 11a3 having a vibration characteristic and may be bent in a curved shape by the second portion 11a4 having flexibility.

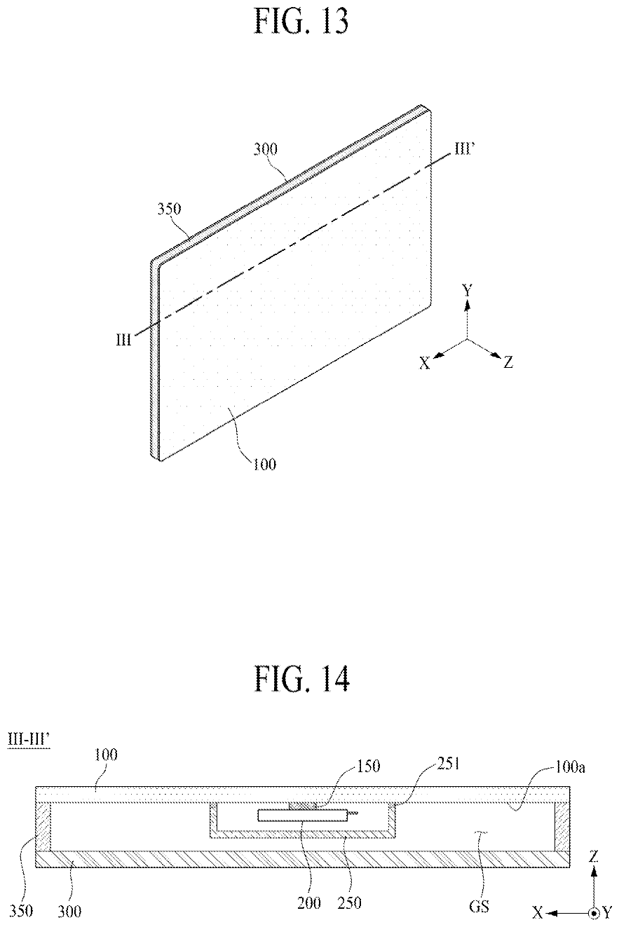

FIG. 13 illustrates an apparatus according to an aspect of the present disclosure. FIG. 14 is a cross-sectional view taken along line of FIG. 13.

Referring to FIGS. 13 and 14, an apparatus according to an aspect of the present disclosure may include a passive vibration member 100 and one or more vibration generating apparatus 200.

The “apparatus” according to an aspect of the present disclosure may be a display apparatus, a sound apparatus, a sound generating apparatus, a sound bar, an analog signage, or a digital signage, or the like, but aspects of the present disclosure are not limited thereto.

The display apparatus may include a display panel including a plurality of pixels which implement a black/white or color image and a driver for driving the display panel. For example, the display panel may be a liquid crystal display panel, an organic light-emitting display panel, a light-emitting diode display panel, an electrophoresis display panel, an electro-wetting display panel, a micro light-emitting diode display panel, or a quantum dot light-emitting display panel, or the like, but aspects of the present disclosure are not limited thereto. For example, in the organic light-emitting display panel, a pixel may include an organic light-emitting device such as an organic light-emitting layer or the like, and the pixel may be a subpixel which implements any one of a plurality of colors configuring a color image. Thus, an “apparatus” according to an aspect of the present disclosure may include a set device (or a set apparatus) or a set electronic device such as a notebook computer, a TV, a computer monitor, an equipment apparatus including an automotive apparatus or another type apparatus for vehicles, or a mobile electronic device such as a smartphone, or an electronic pad, or the like which is a complete product (or a final product) including a display panel such as a liquid crystal display panel or an organic light-emitting display panel, or the like.

The analog signage may be an advertising signboard, a poster, a noticeboard, or the like. The analog signage may include signage content such as a sentence, a picture, and a sign, or the like. The signage content may be disposed at the passive vibration member 100 of the apparatus to be visible. For example, the signage content may be directly attached on the passive vibration member 100 and the signage content may be attached on a medium such as paper by means of printing or the like, and the medium may be attached on the passive vibration member 100.

The passive vibration member 100 may vibrate based on driving (or vibration or displacing) of the one or more vibration generating apparatus 200. For example, the passive vibration member 100 may generate one or more of a vibration and a sound based on driving of the one or more vibration generating apparatus 200.

The passive vibration member 100 according to an aspect of the present disclosure may be a display panel including a display part (or a screen) having a plurality of pixels which implement a black/white or color image. Thus, the passive vibration member 100 may generate one or more of a vibration and a sound based on driving of the one or more vibration generating apparatus 200. For example, the passive vibration member 100 may vibrate based on a vibration of the one or more vibration generating apparatus 200 while a display area is displaying an image, and thus, may generate or output a sound synchronized with the image displayed on the display part. For example, the passive vibration member 100 may be a vibration object, a display member, a display panel, a signage panel, a passive vibration plate, a front cover, a front member, a vibration panel, a sound panel, a passive vibration panel, a sound output plate, a sound vibration plate, or an image screen, or the like, but aspects of the present disclosure are not limited thereto.

The passive vibration member 100 according to another aspect of the present disclosure may include a vibration plate which includes a metal material or a nonmetal material (or a composite nonmetal material) having a material characteristic suitable for outputting a sound based on a vibration of the one or more vibration generating apparatus 200. For example, the passive vibration member 100 may include a vibration plate which includes one or more material of metal, plastic, paper, fiber, cloth, wood, leather, rubber, glass, carbon, and mirror. For example, the paper may be cone paper for speakers. For example, the cone paper may be a pulp or a foamed plastic, or the like, but aspects of the present disclosure are not limited thereto.

The passive vibration member 100 according to another aspect of the present disclosure may include a display panel having a plurality of pixels configured to display an image, or may include a non-display panel. For example, the passive vibration member 100 may include one or more of a display panel having a plurality of pixels configured to display an image, a screen panel on which an image is projected from a display apparatus, a lighting panel, a signage panel, a vehicular interior material, a vehicular exterior material, a vehicular glass window, a vehicular seat interior material, a building ceiling material, a building interior material, a building glass window, an aircraft interior material, an aircraft glass window and mirror, or the like, but aspects of the present disclosure are not limited thereto. For example, the non-display panel may include a light emitting diode lighting panel (or apparatus), an organic light emitting lighting panel (or apparatus), or an inorganic light emitting lighting panel (or apparatus), but aspects of the present disclosure are not limited thereto.

The one or more vibration generating apparatus 200 may be configured to vibrate the passive vibration member 100. The one or more vibration generating apparatus 200 may be configured to be connected to a rear surface of the passive vibration member 100 by a connection member 150. Accordingly, the one or more vibration generating apparatus 200 may vibrate the passive vibration member 100 to generate or output one or more of a vibration and a sound based on a vibration of the passive vibration member 100.

The one or more vibration generating apparatus 200 may include one or more of the vibration apparatus 1, 2, 3, and 4 described above with reference to FIGS. 1 to 12. Accordingly, descriptions of the vibration apparatus 1, 2, 3, and 4 described above with reference to FIGS. 1 to 12 may be included in descriptions of the vibration generating apparatus 200 illustrated in FIGS. 13 and 14, and thus, like reference numerals refer to like elements and repeated descriptions thereof are omitted.

The apparatus according to an aspect of the present disclosure may include a plurality of vibration generating apparatuses 200. As an aspect of the present disclosure, a plurality of vibration generating apparatuses 200 may be disposed at the rear surface 100a of the passive vibration member 100 along the first direction X and/or the second direction Y. As another aspect of the present disclosure, a plurality of vibration generating apparatuses 200 may be configured to be stacked vertically along a thickness direction Z of the passive vibration member 100. The plurality vibration generating apparatuses 200 which are vertically stacked may vibrate (or displace or drive) in the same direction.

The connection member 150 may be disposed between the one or more vibration generating apparatuses 200 and the passive vibration member 100. The connection member 150 may be disposed between at least a portion of the vibration generating apparatus 200 and the passive vibration member 100. The connection member 150 according to an aspect of the present disclosure may be connected between the passive vibration member 100 and a center portion, except a periphery portion, of the vibration generating apparatus 200. For example, the connection member 150 may be connected between the passive vibration member 100 and the center portion of the vibration generating apparatus 200 based on a partial attachment scheme. The center portion (or a central portion) of the vibration generating apparatus 200 may be a center of a vibration, and thus, a vibration of the vibration generating apparatus 200 may be effectively transferred to the passive vibration member 100 through the connection member 150. A periphery portion of the vibration generating apparatus 200 may be spaced apart from each of the connection member 150 and the passive vibration member 100 and lifted without being connected to the connection member 150 and/or the passive vibration member 100, and thus, in a flexural vibration (or a bending vibration) of the vibration generating apparatus 200, a vibration of a periphery portion of the vibration generating apparatus 200 may be prevented (or reduced) by the connection member 150 and/or the passive vibration member 100, whereby a vibration amplitude (or a displacement amplitude) of the vibration generating apparatus 200 may increase. Accordingly, a vibration amplitude (or a displacement amplitude or a driving amplitude) of the passive vibration member 100 based on a vibration of the vibration generating apparatus 200 may increase, and thus, a sound characteristic and/or a sound pressure level characteristic of a low-pitched sound band generated based on a vibration of the passive vibration member 100 may be more enhanced.

The connection member 150 according to another aspect of the present disclosure may be connected to or attached on an entire front surface of each of the one or more vibration generating apparatuses 200 and the rear surface 100a of the passive vibration member 100 based on an entire surface attachment scheme.

The connection member 150 according to an aspect of the present disclosure may include a material including an adhesive layer which is good in adhesive force or attaching force with respect to each of the one or more vibration generating apparatuses 200 and a rear surface of the display panel or a rear surface of the passive vibration member 100. For example, the connection member 150 may include a foam pad, a double-sided tape, or an adhesive, or the like, but aspects of the present disclosure are not limited thereto. For example, the adhesive layer of the connection member 150 may include epoxy, acrylic, silicone, or urethane, but aspects of the present disclosure are not limited thereto. For example, the adhesive layer of the connection member 150 may include an acrylic-based material (or substance), having a characteristic where an adhesive force is relatively good and hardness is relatively high, of acrylic and urethane. Accordingly, a vibration of the one or more vibration generating apparatuses 200 may be well transferred to the passive vibration member 100.

The apparatus according to an aspect of the present disclosure may further include a supporting member 300 and a coupling member 350.

The supporting member 300 may be disposed at the rear surface 100a of the passive vibration member 100. The supporting member 300 may be disposed at the rear surface 100a of the passive vibration member 100 to cover the one or more vibration generating apparatus 200. The supporting member 300 may be disposed on the rear surface 100a of the passive vibration member 100 to cover all of the rear surface 100a of the passive vibration member 100 and the one or more vibration generating apparatus 200. For example, the supporting member 300 may have the same size as the passive vibration member 100. For example, the supporting member 300 may cover a whole rear surface of the passive vibration member 100 with a gap space GS and the one or more vibration generating apparatus 200 therebetween. The gap space GS may be provided by the coupling member 350 disposed between the passive vibration member 100 and the supporting member 300 facing each other. The gap space GS may be referred to as an air gap, an accommodating space, a vibration space, or a sound sounding box, but aspects of the present disclosure are not limited thereto.

The supporting member 300 may include any one of a glass material, a metal material, and a plastic material. For example, the supporting member 300 may include a stacked structure in which one or more of a glass material, a plastic material, and a metal material is stacked thereof.

Each of the passive vibration member 100 and the supporting member 300 may have a square shape or a rectangular shape, but aspects of the present disclosure are not limited thereto, and may have a polygonal shape, a non-polygonal shape, a circular shape, or an oval shape. For example, when the apparatus according to an aspect of the present disclosure is applied to a sound apparatus or a sound bar, each of the passive vibration member 100 and the supporting member 300 may have a rectangular shape where a length of a long side is twice or more times longer than a short side, but aspects of the present disclosure are not limited thereto.

The coupling member 350 may be configured to be connected between a rear periphery portion of the passive vibration member 100 and a front periphery portion of the supporting member 300, and thus, the gap space GS may be provided between the passive vibration member 100 and the supporting member 300 facing each other.

The coupling member 350 according to an aspect of the present disclosure may include an elastic material which has adhesive properties and is capable of compression and decompression. For example, the coupling member 350 may include a double-sided tape, a single-sided tape, a double-sided foam tape, or a double-sided adhesive foam pad, but aspects of the present disclosure are not limited thereto, and may include an elastic pad such as a rubber pad or a silicone pad, or the like, which has adhesive properties and is capable of compression and decompression. For example, the coupling member 350 may be formed by elastomer.

According to another aspect of the present disclosure, the supporting member 300 may further include a sidewall portion which supports a rear periphery portion of the passive vibration member 100. The sidewall portion of the supporting member 300 may protrude or be bent toward the rear periphery portion of the passive vibration member 100 from the front periphery portion of the supporting member 300, and thus, the gap space GS may be provided between the passive vibration member 100 and the supporting member 300. For example, the coupling member 350 may be configured to be connected between the sidewall portion of the supporting member 300 and the rear periphery portion of the passive vibration member 100. Accordingly, the supporting member 300 may cover the one or more vibration generating apparatuses 200 and may support the rear surface 100a of the passive vibration member 100. For example, the supporting member 300 may cover the one or more vibration generating apparatuses 200 and may support the rear periphery portion of the passive vibration member 100.

According to another aspect of the present disclosure, the passive vibration member 100 may further include a sidewall portion which is connected to a front periphery portion of the supporting member 300. The sidewall portion of the passive vibration member 100 may protrude or be bent toward the front periphery portion of the supporting member 300 from the rear periphery portion of the passive vibration member 100, and thus, the gap space GS may be provided between the passive vibration member 100 and the supporting member 300. A stiffness of the passive vibration member 100 may be increased based on the sidewall portion. For example, the coupling member 350 may be configured to be connected between the sidewall portion of the passive vibration member 100 and the front periphery portion of the supporting member 300. Accordingly, the supporting member 300 may cover the one or more vibration generating apparatuses 200 and may support the rear surface 100a of the passive vibration member 100. For example, the supporting member 300 may cover the one or more vibration generating apparatuses 200 and may support the rear periphery portion of the passive vibration member 100.

The apparatus according to an aspect of the present disclosure may further include one or more enclosure 250.

The enclosure 250 may be connected or coupled to the rear periphery portion of the passive vibration member 100 to individually cover the one or more vibration generating apparatuses 200. For example, the enclosure 250 may be connected or coupled to the rear surface 100a of the passive vibration member 100 by a coupling member 251. The enclosure 250 may configure a closed space which covers or surrounds the vibration generating apparatus 200, in the rear surface of the supporting member 300. For example, the enclosure 250 may configure a closed space which covers or surrounds the one or more vibration generating apparatuses 200, in the rear surface 100a of the passive vibration member 100. For example, the enclosure 250 may be a closed member, a closed cap, a closed box, or a sound box, but aspects of the present disclosure are not limited thereto. The closed space may be an air gap, a vibration space, a sound space, or a sounding box, but aspects of the present disclosure are not limited thereto.

The enclosure 250 may include one or more materials of a metal material and a nonmetal material (or a composite nonmetal material). For example, the enclosure 250 may include one or more materials of a metal material, plastic, carbon, and wood, but aspects of the present disclosure are not limited thereto.

The enclosure 250 according to an aspect of the present disclosure may maintain an impedance component based on air acting on the passive vibration member 100 when the passive vibration member 100 or the one or more vibration generating apparatuses 200 is vibrating. For example, air around the passive vibration member 100 may resist a vibration of the passive vibration member 100 and may act as an impedance component having a reactance component and a resistance based on a frequency. Therefore, the enclosure 250 may configure a closed space which surrounds the one or more vibration generating apparatuses 200, in the rear surface 100a of the passive vibration member 100, and thus, may maintain an impedance component (or an air impedance or an elastic impedance) acting on the passive vibration member 100 based on air, thereby enhancing a sound characteristic and/or a sound pressure level characteristic of the low-pitched sound band and enhancing the quality of a sound of a high-pitched sound band.

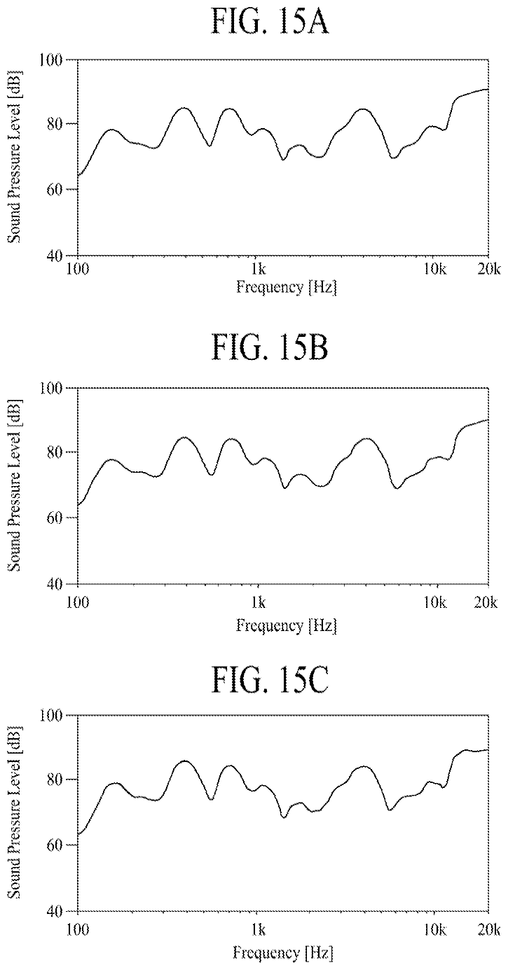

FIG. 15A illustrates a sound output characteristic of a vibration apparatus according to an experimental example. FIG. 15B illustrates a sound output characteristic of a vibration apparatus according to an aspect of the present disclosure. FIG. 15C illustrates a sound output characteristic of a vibration apparatus according to another aspect of the present disclosure. FIG. 15A illustrates a sound output characteristic of the vibration apparatus according to the experimental example including no discharge member. FIG. 15B illustrates a sound output characteristic of the vibration apparatus according to an aspect of the present disclosure including a discharge member having a resistance value of 220Ω. FIG. 15C illustrates a sound output characteristic of the vibration apparatus according to an aspect of the present disclosure including a discharge member having a resistance value of 1 kΩ In FIGS. 15A to 15C, the abscissa axis represents a frequency in hertz (Hz), and the ordinate axis represents a sound pressure level (SPL) in decibels (dB).

A sound output characteristic may be measured by a sound measurement apparatus. The sound measurement apparatus may be configured to include a sound card that may transmit or receive sound to or from a control personal computer (PC), an amplifier that may amplify a signal generated from the sound card and transfer the amplified signal to a vibration apparatus, and a microphone that may collect sound generated by a passive vibration member based on driving of the vibration apparatus. For example, the microphone is disposed at a center of the vibration apparatus, and a separation distance between the passive vibration member and the microphone may be 30 cm. A sound may be measured in state where the microphone is vertical to a vibration apparatus. The sound collected through the microphone may be input to the control PC through the sound card, and a control program may check the input sound to analyze the sound output characteristic of the vibration apparatus. For example, in measuring a sound, an input voltage may be 10 Vrms, and a frequency response characteristic of a frequency range of 100 Hz to 20 kHz may be measured by a pulse program.

As seen in FIGS. 15A to 15C, it may be seen that a vibration apparatus according to an aspect of the present disclosure including a discharge member has a sound output characteristic similar to that of a vibration apparatus according to an experimental example including no discharge member.

Therefore, the vibration apparatus according to an aspect of the present disclosure may minimize or prevent a reduction in reliability caused by a residual electric charge of a vibration part without a reduction in sound characteristic and/or sound pressure level characteristic.

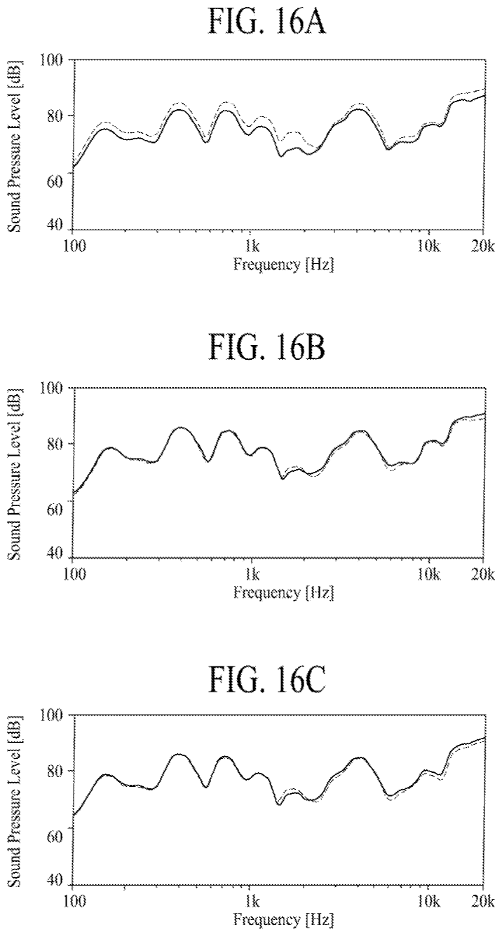

FIG. 16A illustrates a sound output characteristic of a vibration apparatus according to an experimental example with respect to a thermal shock. FIG. 16B illustrates a sound output characteristic of a vibration apparatus according to an aspect of the present disclosure with respect to a thermal shock. FIG. 16C illustrates a sound output characteristic of a vibration apparatus according to another aspect of the present disclosure with respect to a thermal shock. FIG. 16A illustrates a sound output characteristic of the vibration apparatus according to the experiment example including no discharge member. FIG. 16B illustrates a sound output characteristic of the vibration apparatus according to an aspect of the present disclosure including a discharge member having a resistance value of 220Ω with respect to a thermal shock. FIG. 16C illustrates a sound output characteristic of the vibration apparatus according to an aspect of the present disclosure including a discharge member having a resistance value of 1 kΩ with respect to a thermal shock. In FIGS. 16A to 16C, the abscissa axis represents a frequency in hertz (Hz), and the ordinate axis represents a sound pressure level (SPL) in decibels (dB).

A measurement method of a sound output characteristic may be as described above with reference to FIGS. 15A to 15C, and thus, repeated descriptions are omitted. In the measurement method, a thermal shock has been applied to a vibration apparatus by repeating, 100 times, a cycle where an internal temperature of a chamber where the vibration apparatus is disposed increase up to 85 degrees C. from −45 degrees C. and decreases from 85 degrees C. to −45 degrees C. again. In each of FIGS. 16A to 16C, a dotted line represents a sound output characteristic of a vibration apparatus to which a thermal shock is not applied, and a thick solid line represents a sound output characteristic of a vibration apparatus to which a thermal shock is applied.

As seen in FIG. 16A, it may be seen that the vibration apparatus according to the experimental example is reduced in sound pressure level characteristic due to a thermal shock. For example, in the vibration apparatus according to the experimental example, it may be seen that an average sound pressure level of a dotted line has about 77.4 dB and an average sound pressure level of a thick solid line has about 74.7 dB, and thus, an average sound pressure level of the vibration apparatus according to the experimental example decreases by about 2.7 dB when a thermal shock occurs.

As seen in FIGS. 16B, it may be seen that the vibration apparatus according to an aspect of the present disclosure including a discharge member having a resistance value of 220Ω is not reduced in sound pressure level characteristic due to a thermal shock. For example, in the vibration apparatus according to an aspect of the present disclosure, it may be seen that an average sound pressure level of a dotted line has about 77.3 dB and an average sound pressure level of a thick solid line has about 77.8 dB, and thus, an average sound pressure level of the vibration apparatus according to an aspect of the present disclosure increases by about 0.5 dB without being reduced when a thermal shock occurs.

As seen in FIGS. 16C, it may be seen that the vibration apparatus according to an aspect of the present disclosure including a discharge member having a resistance value of 1 kΩ is not reduced in sound pressure level characteristic due to a thermal shock. For example, in the vibration apparatus according to an aspect of the present disclosure, it may be seen that an average sound pressure level of a dotted line has about 77.8 dB and an average sound pressure level of a thick solid line has about 78.0 dB, and thus, an average sound pressure level of the vibration apparatus according to an aspect of the present disclosure increases by about 0.20 dB without being reduced when a thermal shock occurs.

Therefore, in the vibration apparatus according to an aspect of the present disclosure, a reduction in reliability caused by a residual electric charge of a vibration part may be minimized or prevented without a reduction in sound characteristic and/or sound pressure level characteristic in various temperature environments.

A vibration apparatus and an apparatus including the same according to an aspect of the present disclosure will be described below.

A vibration apparatus according to an aspect of the present disclosure may comprise a vibration layer including a piezoelectric material, a first electrode layer at a first surface of the vibration layer, a second electrode layer at a second surface of the vibration layer different from the first surface, and a discharge member electrically connected to the first electrode layer and the second electrode layer.

According to one or more aspects of the present disclosure, the discharge member may have a resistance value of 100Ω or more.

According to one or more embodiments of the present disclosure, the discharge member may be electrically connected to at least a portion of a surface of the first electrode layer, the surface of the first electrode layer facing away from the first surface of the vibration layer, and to at least a portion of a surface of the second electrode layer, the surface of the second electrode layer facing away from the second surface of the vibration layer. Additionally or alternatively, the discharge member may be disposed at or along a lateral surface of the vibration layer.

According to one or more aspects of the present disclosure, the second electrode layer may be at the second surface, which is opposite to the first surface. The discharge member may be electrically connected between or to at least a portion of the first electrode layer and at least a portion of the second electrode layer, at one lateral surface of the vibration layer.

According to one or more aspects of the present disclosure, the discharge member may comprise a conductive material, or the discharge member may comprise a conductive material having a resistance value.

According to one or more aspects of the present disclosure, the discharge member may comprise a conductive tape, or a conductive paste, or may comprise a conductive tape having the resistance value, or may be implemented by a conductive paste having the resistance value.

According to one or more aspects of the present disclosure, the discharge member may comprise a base film, and a conductive adhesive layer at the base film to have the resistance value. The conductive adhesive layer may be on the base film and may have a predetermined resistance value.

According to one or more aspects of the present disclosure, the conductive adhesive layer may comprise an adhesive and conductive particles. The conductive particles may comprise one or more of a metal material, a nonmetal material, and a conductive polymer material.

According to one or more aspects of the present disclosure, the vibration apparatus may further comprise a signal supply member, the signal supply member may comprise a first signal line electrically connected to the first electrode layer, and a second signal line electrically connected to the second electrode layer.

According to one or more aspects of the present disclosure, the discharge member may be configured at the signal supply member.

According to one or more aspects of the present disclosure, the discharge member may comprise a resistance member electrically connected between the first signal line and the second signal line. For example, the resistance member may have a resistance value of 100Ω (ohm) or more.

According to one or more aspects of the present disclosure, the discharge member may comprise a resistance member and a switch member electrically connected in series between the first signal line and the second signal line. For example, the resistance member may have a resistance value of 100Ω (ohm) or more.

According to one or more aspects of the present disclosure, the vibration apparatus may further comprise a first cover member covering the first electrode layer, and a second cover member covering the second electrode layer. A portion of the signal supply member may be between the first cover member and the second cover member.

According to one or more aspects of the present disclosure, the vibration apparatus may further comprise a printed circuit board electrically connected to the signal supply member.

According to one or more aspects of the present disclosure, the discharge member may be configured at the printed circuit board.

According to one or more aspects of the present disclosure, the printed circuit board may comprise a first conductive line electrically connected to the first signal line of the signal supply member, and a second conductive line electrically connected to the second signal line of the signal supply member.

According to one or more aspects of the present disclosure, the discharge member may comprise a resistance member electrically connected between the first signal line and the second signal line. For example, the resistance member may have a resistance value of 100Ω (ohm) or more.

According to one or more aspects of the present disclosure, the discharge member may comprise a resistance member and a switch member electrically connected in series between the first signal line and the second signal line. For example, the resistance member may have a resistance value of 100Ω (ohm) or more.

According to one or more aspects of the present disclosure, the vibration apparatus may further comprise a vibration driving circuit electrically connected to the printed circuit board, the switch member may be a transistor turned on or off by a switching signal supplied from the vibration driving circuit.

According to one or more embodiments of the present disclosure, the first electrode layer may be formed at an entire first surface of the vibration layer other than a periphery portion, and the second electrode layer may be formed at an entire second surface of the vibration layer other than a periphery portion.

According to one or more embodiments of the present disclosure, the vibration layer may be a capacitor or a piezoelectric capacitor, the discharge member may be configured to be electrically connected to the capacitor in parallel.

According to one or more embodiments of the present disclosure, one or more of the first cover member and the second cover member may include an adhesive member, and a protection member which covers the adhesive member.

According to one or more embodiments of the present disclosure, an end portion of the signal supply member may be inserted between the first surface of the vibration layer and the first cover member.

According to one or more embodiments of the present disclosure, the discharge member may be disposed at a same layer as the first signal line and the second signal line.

According to one or more embodiments of the present disclosure, the discharge member may be disposed at a same layer as the first conductive line and the second conductive line.

According to one or more embodiments of the present disclosure, the vibration layer may include a plurality of first portions; and a plurality of second portions, each of the plurality of first portion may be disposed between two adjacent second portions of the plurality of second portion, each of the plurality of first portions may include an inorganic material having a piezoelectric effect, and each of the plurality of second portions may include an organic material having a flexible characteristic.

An apparatus according to an aspect of the present disclosure may comprise a passive vibration member, and at least one vibration generating apparatus configured to vibrate the passive vibration member, the at least one vibration generating apparatus may comprise the vibration apparatus. The vibration apparatus may comprise a vibration layer including a piezoelectric material, a first electrode layer at a first surface of the vibration layer, a second electrode layer at a second surface of the vibration layer different from the first surface, and a discharge member electrically connected to the first electrode layer and the second electrode layer.

According to one or more aspects of the present disclosure, the apparatus may further comprise an enclosure disposed at a rear surface of the passive vibration member to cover the at least one vibration generating apparatus.

According to one or more aspects of the present disclosure, the passive vibration member may comprise a vibration plate which includes one or more materials of metal, plastic, wood, paper, fiber, cloth, leather, glass, rubber, carbon, and mirror, or one or more of a display panel including a pixel configured to display an image, a screen panel on which an image is to be projected from a display apparatus, a light emitting diode lighting panel, an organic light emitting lighting panel, an inorganic light emitting lighting panel, a signage panel, a vehicular interior material, a vehicular exterior material, a vehicular glass window, a vehicular seat interior material, a building ceiling material, a building interior material, a building glass window, an aircraft interior material, an aircraft glass window, and a mirror.

A vibration apparatus according to one or more aspects of the present disclosure may be applied to or included in a vibration apparatus disposed at an apparatus. The apparatus according to an aspect of the present disclosure may be applied to or included in mobile apparatuses, video phones, smart watches, watch phones, wearable apparatuses, foldable apparatuses, rollable apparatuses, bendable apparatuses, flexible apparatuses, curved apparatuses, sliding apparatuses, variable apparatuses, electronic organizers, electronic books, portable multimedia players (PMPs), personal digital assistants (PDAs), MP3 players, mobile medical devices, desktop personal computers (PCs), laptop PCs, netbook computers, workstations, navigation apparatuses, automotive navigation apparatuses, automotive display apparatuses, automotive apparatuses, theater apparatuses, theater display apparatuses, TVs, wall paper display apparatuses, signage apparatuses, game machines, notebook computers, monitors, cameras, camcorders, and home appliances, or the like. In addition, the vibration apparatus according to one or more aspects of the present disclosure may be applied to or included in an organic light-emitting lighting apparatus or an inorganic light-emitting lighting apparatus. When the vibration apparatus is applied to or included in the lighting apparatuses, the lighting apparatuses may act as lighting and a speaker. In addition, when the vibration apparatus according to one or more aspects of the present disclosure is applied to or included in the mobile apparatuses, or the like, the vibration apparatus may be one or more of a speaker, a receiver, and a haptic device, but aspects of the present disclosure are not limited thereto.

It will be apparent to those skilled in the art that various modifications and variations may be made in the present disclosure without departing from the scope of the disclosure. Thus, it is intended that the present disclosure covers the modifications and variations of this disclosure provided that within the scope of the claims and their equivalents.

What is claimed is:

1. A vibration apparatus, comprising:
a vibration layer including a piezoelectric material;
a first electrode layer disposed at a first surface of the vibration layer;
a second electrode layer disposed at a second surface of the vibration layer different from the first surface; and
a discharge member electrically connected to the first electrode layer and the second electrode layer.

2. The vibration apparatus of claim 1, wherein the discharge member has a resistance value of 100Ω or more.

3. The vibration apparatus of claim 1, wherein the second surface is opposite to the first surface of the vibration layer; and
wherein the discharge member is disposed at a lateral surface of the vibration layer.

4. The vibration apparatus of claim 3, wherein the discharge member comprises a conductive material.

5. The vibration apparatus of claim 3, wherein the discharge member comprises a conductive tape, or a conductive paste.

6. The vibration apparatus of claim 3, wherein the discharge member comprises:
a base film; and
a conductive adhesive layer disposed on the base film, the conductive adhesive layer having a predetermined resistance value.

7. The vibration apparatus of claim 6, wherein the conductive adhesive layer comprises an adhesive and conductive particles, and
wherein the conductive particles comprise one or more of a metal material, a nonmetal material, and a conductive polymer material.

8. The vibration apparatus of claim 1, further comprising a signal supply member,
wherein the signal supply member comprises:
a first signal line electrically connected to the first electrode layer; and
a second signal line electrically connected to the second electrode layer.

9. The vibration apparatus of claim 8, wherein the discharge member is configured at the signal supply member.

10. The vibration apparatus of claim 8, wherein the discharge member comprises a resistance member electrically connected between the first signal line and the second signal line.

11. The vibration apparatus of claim 8, wherein the discharge member comprises a resistance member and a switch member electrically connected in series between the first signal line and the second signal line.

12. The vibration apparatus of claim 8, further comprising:
a first cover member covering the first electrode layer; and
a second cover member covering the second electrode layer,
wherein a portion of the signal supply member is disposed between the first cover member and the second cover member.

13. The vibration apparatus of claim 8, further comprising a printed circuit board electrically connected to the signal supply member.

14. The vibration apparatus of claim 13, wherein the discharge member is configured at the printed circuit board.

15. The vibration apparatus of claim 13, wherein the printed circuit board comprises:
a first conductive line electrically connected to the first signal line of the signal supply member; and
a second conductive line electrically connected to the second signal line of the signal supply member.

16. The vibration apparatus of claim 15, wherein the discharge member comprises a resistance member electrically connected between the first signal line and the second signal line.

17. The vibration apparatus of claim 15,
wherein the discharge member comprises a resistance member and a switch member electrically connected in series between the first signal line and the second signal line.

18. The vibration apparatus of claim 17, further comprising a vibration driving circuit electrically connected to the printed circuit board,
wherein the switch member is a transistor turned on or off by a switching signal supplied from the vibration driving circuit.

19. The vibration apparatus of claim 1, wherein the first electrode layer is formed at an entire first surface of the vibration layer other than a periphery portion, and the second electrode layer is formed at an entire second surface of the vibration layer other than a periphery portion.

20. The vibration apparatus of claim 1, wherein the vibration layer is a capacitor or a piezoelectric capacitor,
wherein the discharge member is configured to be electrically connected to the capacitor in parallel.

21. The vibration apparatus of claim 12, wherein one or more of the first cover member and the second cover member include:
an adhesive member; and
a protection member which covers the adhesive member.

22. The vibration apparatus of claim 12, wherein an end portion of the signal supply member is inserted between the first surface of the vibration layer and the first cover member.

23. The vibration apparatus of claim 8, wherein the discharge member is disposed at a same layer as the first signal line and the second signal line.

24. The vibration apparatus of claim 15, wherein the discharge member is disposed at a same layer as the first conductive line and the second conductive line.

25. The vibration apparatus of claim 1, wherein the vibration layer includes:
a plurality of first portions; and a plurality of second portions, wherein each of the plurality of first portion is disposed between two adjacent second portions of the plurality of second portion,
wherein each of the plurality of first portions includes an inorganic material having a piezoelectric effect, and
wherein each of the plurality of second portions includes an organic material having a flexible characteristic.

26. An apparatus, comprising:
a passive vibration member; and
at least one vibration generating apparatus configured to vibrate the passive vibration member,
wherein the at least one or more vibration generating apparatus comprises the vibration apparatus of claim 1.

27. The apparatus of claim 29, further comprising an enclosure disposed at a rear surface of the passive vibration member and covering the at least one vibration generating apparatus.

28. The apparatus of claim 26, wherein the passive vibration member comprises:
a vibration plate which includes one or more materials of metal, plastic, wood, paper, fiber, cloth, leather, glass, rubber, carbon, and mirror, or
one or more of a display panel including a pixel configured to display an image, a screen panel on which an image is to be projected from a display apparatus, a light emitting diode lighting panel, an organic light emitting lighting panel, an inorganic light emitting lighting panel, a signage panel, a vehicular interior material, a vehicular exterior material, a vehicular glass window, a vehicular seat interior material, a building ceiling material, a building interior material, a building glass window, an aircraft interior material, an aircraft glass window, and a mirror.
